(19) United States
(12) Patent Application Publication
(10) Pub. No.: US 2008/0316404 A1
(43) Pub. Date: Dec. 25, 2008

(54) Liquid Crystal Display Unit

(75) Inventors: Takeyuki Yamaki, Osaka-fu (JP); Hiroshi Yokogawa, Osaka-fu (JP); Akira Tsujimoto, Osaka-fu (JP); Ryozo Fukuzaki, Osaka-fu (JP); Tetsuya Toyoshima, Tokyo (JP); Masanori Yoshihara, Tokyo (JP); Kohei Arakawa, Tokyo (JP)

Correspondence Address: BIRCH STEWART KOLASCH & BIRCH, PO BOX 747, FALLS CHURCH, VA, 22040-0747, US

(73) Assignees: Matsushita Electric Works, Ltd., Kadoma-shi, Osaka-fu (JP); Zeon Corporation, Tokyo (JP)

(21) Appl. No.: 11/793,718

(22) PCT Filed: Dec. 21, 2005
(86) PCT No.: PCT/JP05/23502

§ 371 Date: Aug. 1, 2008

(30) Foreign Application Priority Data
Dec. 25, 2004 (JP) 2004-382816

(51) Int. Cl. G02F 1/13363

(52) U.S. Cl. 349/118

(57) ABSTRACT

A vertical alignment (VA) mode liquid crystal display unit having at least one biaxial optical anisotropic substance sheet and a liquid crystal cell between a light emission side polarizing polarizer and a light incident side polarizer, wherein (1) nₓ>n_{y}>n_{z} is satisfied (nₓ and n_{y}: in-plane principal refractive indexes of the entire biaxial optical anisotropy, and n_{z}: a principal refractive index in the thickness direction), (2) the low refractive index layer comprises an aerogel with a refractive index of up to 1.7, and (3) a multilayered body consisting of the total biaxial optical anisotropic substance sheet and the liquid crystal cell satisfies the formula: |R₄₀−R₀|≦35 nm where R₀: a retardation as measured without imposition of voltage when light with wavelength of 550 nm impinges vertically, and R₄₀: a retardation as measured without imposition of voltage when light with wavelength of 550 nm impinges at an inclination angle of 40 degrees from the normal to the direction of the principal axis.

### TECHNICAL FIELD

This invention relates to a liquid crystal display unit. More particularly, it relates to a liquid crystal display unit having a broad viewing angle, exhibiting no or minimized undesirable mirroring, having an enhanced abrasive resistance, and giving good qualified images at black display for broad viewing angles, and homogeneous images with a high contrast.

### BACKGROUND ART

Heretofore, as a liquid crystal display unit (hereinafter abbreviated to “LCD” when appropriate), a twisted nematic (TN) mode liquid crystal display unit has been popularly used which has a structure such that a liquid crystal having an anisotropic property for a positive dielectric constant is horizontally arranged between two substrates. In the TN mode display unit, when images are manifested at black display, liquid crystal molecules in the immediate vicinity of the substrates exhibit birefringence and consequently light leakage occurs, and thus, good high-quality black display is difficult to attain.

In contrast, in a vertically alignment (VA) mode liquid crystal display unit, liquid crystal molecules are aligned approximately vertically to the substrate surface when voltage is not imposed, and therefore, light is transmitted through a liquid crystal without substantial variation in the plane of polarization. Consequently, in a structure such that polarizing sheets are arranged on both outer sides of the substrate/liquid crystal/substrate assembly, good high-quality black display can be attained when voltage is not imposed. The VA mode liquid crystal display specifically includes, for example, a multi-domain vertical alignment (MVA) mode liquid crystal display unit and a patterned vertical alignment (PVA) mode liquid crystal display unit.

In the VA mode liquid crystal display unit, good high-quality black display can be attained when the display is viewed from the perpendicular direction, but, when the display is viewed from a direction inclined from the normal direction, light leakage occurs due to birefringence of liquid crystal, and a high-quality black display is difficult to attain, and consequently, the viewing angle undesirably becomes narrow.

Therefore, at least one phase film must be arranged for obtaining a broad viewing angle in the VA mode liquid crystal display as well as the NT mode liquid crystal display unit.

Thus, as an example of the VA mode liquid crystal display unit, a liquid crystal display provided with a biaxial phase film satisfying the inequality: nₓ>n_{y}>n_{z} where nₓ and n_{y} are in-plane principal refractive indexes and n_{z} is a principal refractive index in the thickness direction, and exhibiting an in-plane retardation of not larger than 120 nm has been proposed in Japanese Patent No. 3330574.

Another example of the VA mode liquid crystal display has been proposed in Japanese Unexamined Patent Publication No. 2003-307735, which is provided with a biaxial phase film satisfying the inequality: nₓ>n_{y}>n_{z}, and exhibiting a ratio of a retardation in in-plane direction to a retardation in the thickness direction, of at least 2 to broaden the viewing angle, and further the phase film having laminated on the light emission side thereof an antiglare layer and an antireflection layer to more enhance the contrast. This antireflection layer comprises at least two layers including a high refractive index layer and a low refractive index layer to attain the desired antireflection effect. However, the antireflection effect of the laminated type antireflection layer greatly varies depending upon the wavelength, and the liquid crystal display unit having the biaxial phase film with the antireflection layer gives a reflected light which is tinged with a color and liable to be varied depending on the viewing angle. In addition, a problem arises in that the productivity of the multilayer film with a large surface area using a vacuuming apparatus is lowered.

### DISCLOSURE OF THE INVENTION

### Problems to Be Solved by the Invention

A primary object of the present invention is to provide a liquid crystal display unit having a broad viewing angle, exhibiting no or minimized undesirable mirroring, having an enhanced abrasive resistance, and giving good qualified images at black display for broad viewing angles, and homogeneous images with a high contrast.

### Means for Solving the Problems

The present inventors have found that the liquid crystal display unit having a broad viewing angle, exhibiting no or minimized undesirable mirroring, having an enhanced abrasive resistance, and giving good qualified images at black display for broad viewing angles, and homogeneous images with a high contrast, can be provided by a vertical alignment (VA) mode liquid crystal display unit having at least one biaxial optical anisotropic substance sheet having three different principal refractive indexes and a liquid crystal cell between a pair of polarizers; wherein a multilayered body consisting of the total biaxial optical anisotropic substance sheet or sheets and the liquid crystal cell satisfies the formula: |R₄₀−R₀|≦35 nm where R₀ is a retardation as measured without imposition of voltage when light with 550 nm wavelength impinges vertically, and R₄₀ is a retardation as measured without imposition of voltage when light 550 nm wavelength impinges at an inclination angle of 40 degrees from the normal; and wherein the light emission side polarizing sheet is provided with a low refractive index layer comprising an aerogel and having a refractive index of not larger than 1.37, laminated on a light emission side of the light emission side polarizing sheet. Based on the above-mentioned finding, the present invention has been completed.

Thus, in accordance with the present invention, there is provided a vertical alignment (VA) mode liquid crystal display unit having at least one biaxial optical anisotropic substance sheet and a liquid crystal cell between a light emission side polarizing sheet comprising a light emission side polarizer, and a light incident side polarizing sheet comprising a light incident side polarizer, characterized in that:

the entire biaxial optical anisotropic substance sheet satisfies the following formula:

nₓ>n_{y}>n_{z}

where nₓ and n_{y} are in-plane principal refractive indexes of the entire biaxial optical anisotropic substance sheet and n_{z} is a principal refractive index in the thickness direction thereof;

the light emission side polarizing sheet is provided with a low refractive index layer comprising an aerogel and having a refractive index of not larger than 1.37, laminated on a light emission side of the light emission side polarizing sheet; and

a multilayered body consisting of the total biaxial optical anisotropic substance sheet or sheets and the liquid crystal cell satisfies the following formula:

|R₄₀−R₀|≦35 nm

where R₀ is a retardation as measured without imposition of voltage when light having a wavelength of 550 nm impinges vertically, and R₄₀ is a retardation as measured without imposition of voltage when light having a wavelength of 550 nm impinges at an inclination angle of 40 degrees from the normal to the direction of the principal axis.

### Effect of the Invention

The liquid crystal display apparatus according to the present invention is characterized (i) as having a biaxial optical anisotropic substance sheet or sheets having a specific refractive index; (ii) in that a multilayered body consisting of the biaxial optical anisotropic substance sheet or sheets and the liquid crystal cell exhibits a small difference between a retardation as measured when light impinges vertically, and a retardation as measured when light impinges at an inclination angle of 40 degrees, and (iii) as being provided with a low refractive index layer laminated on the viewing side of the light emission side polarizer; and hence, the liquid crystal display has a broad viewing angle, exhibits no or minimized undesirable mirroring, has an enhanced abrasive resistance, and gives good qualified images at black display for broad viewing angles, and homogeneous images with a high contrast.

When the light transmission axis of the light emission side polarizer or the light incident side polarizer is arranged so that the light transmission axis is approximately parallel or approximately perpendicular to the slow axis of the multilayered body consisting of the total biaxial optical anisotropic substance sheet or sheets and the liquid crystal cell without imposition of voltage, the phase difference occurring due to the liquid crystal in the liquid crystal cell can be compensated and the viewing angle of the polarizer can be compensated.

Consequently the phase difference occurring in the light having transmitted through the liquid crystal cell is effectively compensated with the results that light leakage can be prevented or minimized and a high contrast can be attained in all the azimuthal angles.

The liquid crystal display apparatus according to the present invention is suitable for a large-size flat panel display, for example.

### BRIEF DESCRIPTION OF THE DRAWINGS

FIG. 1 is an explanatory view for measurement of retardation R₄₀ᵢ

FIG. 2 is an explanatory view illustrating an embodiment of multilayer structure of a liquid crystal display according to the present invention.

FIG. 3 is an explanatory view illustrating another embodiment of multilayer structure of a liquid crystal display according to the present invention.

### EXPLANATION OF REFERENCE NUMERALS

1, 11: Incident side polarizer
2, 12: Optically anisotropic substance sheet
3, 13. Liquid crystal cell
4: Optically anisotropic substance sheet
5, 14: Light emission side polarizer
6, 15: Low refractive index layer and hard coat layer

### BEST MODE FOR CARRYING OUT THE INVENTION

The liquid crystal display unit according to the present invention is a vertical alignment (VA) mode liquid crystal display unit having at least one biaxial optical anisotropic substance sheet and a liquid crystal cell between a light emission side polarizer and a light incident side polarizer, which have light transmission axes perpendicular to each other. That is, the liquid crystal display unit comprises a VA mode liquid crystal cell, at least one biaxial optical anisotropic substance sheet, a light emission side polarizer and a light incident side polarizer.

The VA mode liquid crystal cell used in the present invention has characteristics such that the liquid crystal molecules are aligned approximately perpendicularly to the substrate surface when a voltage is not imposed, and aligned approximately in parallel to the substrate surface when a voltage is imposed. The VA mode liquid crystal display unit specifically includes, for example, a multi-domain vertical alignment (MVA) made liquid crystal display unit and a patterned vertical alignment (PVA) mode liquid crystal display unit.

The entire biaxial optical anisotropic substance sheet or sheets in the liquid crystal display of the invention satisfy the following formula:

nₓ>n_{y}>n_{z}

where nₓ and n_{y} are in-plane principal refractive indexes of the entire biaxial optical anisotropic substance sheet and n_{z} is a principal refractive index in the thickness direction thereof. The directions in which the in-plane principal refractive indexes nₓ and n_{y} are manifested are referred to as slow axis x and slow axis y, respectively.

When the relationship of formula: nₓ>n_{y}>n_{z} is satisfied, light leakage can be prevented or minimized even when the panel of liquid crystal display unit is viewed from an inclined direction, and an image of a high contrast can be manifested. By the term “contrast” as used herein, we mean a contrast ratio (CR) expressed by a ratio of Yₒₙ/Y_{off} where Y_{off} is a luminance at dark display of the liquid crystal display unit, and Yₒₙ is a luminance at light display of the liquid crystal display unit. The larger the contrast ratio, the better the visibility. The light display refers to the lightest state of display surface of the liquid crystal display unit and the black display refers to the darkest state of display surface of the liquid crystal display unit.

The relationship of formula: nₓ>n_{y}>n_{z} may be satisfied either by a single optical anisotropic substance sheet, or by two or more optical anisotropic substance sheets. For example, the relationship of formula: nₓ>n_{y}>n_{z} can be satisfied by a laminate consisting of two optical anisotropic substance sheets, one of which satisfies a relationship of formula: nₓ>n_{y}=n_{z}, and the other of which satisfies a relationship of formula: nₓ=n_{y}>n_{z}.

The biaxial optical anisotropic substance sheet used in the present invention is prepared by stretching a film made of transparent resin. The transparent resin is not particularly limited provided that a shaped article having a thickness of 1 am, made thereof, exhibits a total luminous transmittance of at least 80%.

As specific examples of the transparent resin, there can be mentioned polymers having an alicyclic structure, cellulose esters, polyimides, chain olefin polymers such as polyethylene and polypropylene, polycarbonates, polyesters, polysulfones, polyether-sulfones, polystyrene, polyvinyl alcohol and polymethacrylates. These transparent resins may be used either alone or as a combination of at least two thereof. Of these, polymers having an alicyclic structure and chain olefin polymers are preferable. Polymers having an alicyclic structure are especially preferable because of high transparency, low moisture-absorption, good dimensional stability and lightness in weight.

The method for making the above-mentioned transparent resin film is not particularly limited, and the film can be made by conventional methods which include for example, a solution-casting method and a melt extrusion method. Of these, a melt extrusion method using no solvent is preferable because a film containing a reduced amount of volatile ingredients and having a thickness of at least 100 μm and a large Rₜₕ can easily be made at a low production cost. The melt extrusion method includes, for example, an extrusion method using a die, and an inflation method. Of these, an extrusion method using a T-die is preferable because of reduced production cost and enhanced thickness precision. By the term “Rₜₕ” as used herein, we mean a retardation in the thickness direction, which is defined by the following formula:

Rₜₕ=[(nₓ+n_{y})/2−n_{z}]×film thickness(μm)

In the extrusion method using a T-die, a transparent resin is Led in an extruder provided with a T-die; the transparent resin is heated at a temperature usually 80-180° C. higher, preferably 100-150° C. higher, than the glass transition temperature of the transparent resin to be thereby melted; the molten resin is then extruded through the T-die, and the extruded molten resin is quenched and formed into a film. If the temperature for melting the transparent resin is too low, the transparent resin tends to have poor fluidity. In contrast, if the melting temperature is too high, the transparent resin is liable to be deteriorated.

The film made of the transparent resin (which is hereinafter referred to as “raw film” when appropriate) is stretched. The stretching method and conditions are appropriately chosen so as to give a film satisfying the formula: nₓ>n_{y}>n_{z}. The stretching method preferably includes, for example, a uniaxial transverse stretching method and a biaxial stretching method, in both of which a tenter stretcher is used. The tenter stretcher used includes, for example, a pantograph type tenter stretcher, a screw type tenter stretcher and a linear motor type tenter stretcher.

The biaxial stretching method includes a sequential biaxial stretching method wherein the raw film is stretched sequentially in the longitudinal direction and the transverse direction; and a concurrent biaxial stretching method wherein the raw film is stretched concurrently in the longitudinal direction and the transverse direction. Of these, a concurrent biaxial stretching method is preferable because the process of stretching can be simplified, the stretched film is not easily split, and the retardation Rₜₕ in the thickness direction can be large.

The concurrent biaxial stretching method comprises the steps of pre-heating a raw film (pre-heating step), biaxially stretching the pre-heated film concurrently in the longitudinal direction and in the transverse direction (stretching step), and relaxing the biaxially stretched film (i.e., optically anisotropic film) (heat-setting step).

In the pre-heating step, the raw film was heated to a temperature usually in the range of [stretching temperature −40° C.] to [stretching temperature+20° C.], preferably [stretching temperature−30° C.] to [stretching temperature+15° C.].

In the stretching step, the pre-heated film was stretched while being maintained at a temperature preferably in the range of Tg-30° C. to Tg+60° C., more preferably Tg−10° C. to Tg+50° C., where Tg is glass transition temperature of the transparent resin. The stretching ratio is not particularly limited, provided that the desired refractive index is attained, but the stretching ratio is usually at least 1.3, preferably in the range of 1.3 to 3.

In the heat-setting step, the stretched film is maintained usually in the range of [room temperature] to [stretching temperature+30° C.], preferably [stretching temperature−40° C.] to [stretching temperature+20° C.].

Heating means (or temperature-controlling means) adopted in the pre-heating step, the stretching step and the heat-setting step includes, for example, an oven heating apparatus, a radiation heating apparatus, and a dip-heating means for immersing the film in a temperature-controlled liquid bath. Of these, an oven heating apparatus is preferable. An oven heating apparatus of the type wherein warm air is blown against the upper and lower surfaces of the raw, pre-heated or stretched film) is especially preferable because a uniform temperature distribution can be attained.

The light emission side polarizing sheet used in the present invention comprises a light emission side polarizer. The light incident side polarizing sheet used in the present invention comprises a light incident side polarizer.

The light emission side polarizer and the light incident side polarizer can convert natural light to a linear polarized light. As specific examples of the light polarizers, there can be mentioned those which are produced by subjecting a film made of a vinyl alcohol polymer such as polyvinyl alcohol and partially formalized polyvinyl alcohol, to a dyeing treatment using dichromatic substance such as a dichromatic dye, and iodine, a stretching treatment and a crosslinking treatment. The thickness of polarizers is not particularly limited, but is preferably in the range of 5 to 80 pa.

The light transmission axis of the light emission side polarizer and the light transmission axis of the light incident side polarizer are approximately perpendicular to each other. By the term “approximately perpendicular” as used herein, we mean that an angle formed between the two light transmission axes (this angle refers to that within the range of 0 to 90 degrees) is usually within the range of 87 to 90 degrees and preferably 89 to 90 degrees. If the angle formed between the two light transmission axes is smaller than 87 degrees, light leaks and image quality at black display is liable to be deteriorated.

The light incident side polarizer of the light incident side polarizing sheet and the light emission side polarizer of the light emission side polarizing sheet usually have protective films adhered on both sides of the respective polarizers.

The protective film is preferably made of a polymer having high transparency, mechanical strength, heat stability and water repellency. As specific examples of such polymer, there can be mentioned polymers having an alicyclic structure, polyolefin, polycarbonate, polyethylene terephthalate, polyvinyl chloride, polystyrene, polyacrylonitrile, polysulfone, polyether-sulfone, polyarylate, triacetyl cellulose, and acrylic acid ester or methacrylic acid ester-vinyl aromatic compound copolymers. Of these, polymers having an alicyclic structure, and polyethylene terephthalate are preferable in view of good transparency, light-weight, dimensional stability and film-thickness controllability. Triacetyl cellulose is also preferable view of good transparency and light-weight.

The polymer having an alicyclic structure includes, for example, a norbornene polymer, a polymer of cycloolefin with a single ring, and a polymer of a hydrocarbon monomer having a vinyl group and an alicyclic structure. Of these, a norbornene polymer is preferably used because of high transparency and good shapability. The norbornene polymer includes, for example, a polymer prepared by ring-opening polymerization of a norbornene monomer, a copolymer prepared by ring-opening copolymerization of a norbornene monomer with other monomer, and hydrogenation products of these polymers; and an addition polymer of a norbornene monomer, an addition copolymer of a norbornene monomer with other monomer, and hydrogenation products of these polymers. Of these, a hydrogenation product of a polymer prepared by ring-opening polymerization of a norbornene monomer and a hydrogenation product of a copolymer prepared by ring-opening copolymerization of a norbornene monomer with other monomer are especially preferable because of high transparency.

In the case when the liquid crystal display has a multilayer structure wherein each polarizer is arranged in direct contact with the biaxial optical anisotropic substance sheet, the biaxial optical anisotropic substance sheet may have a function of protecting the polarizer. In this case, the biaxial optical anisotropic substance sheet as a protective film is adhered onto the inner side of the light incident side polarizer and the inner side of the light emission side polarizer, which sides are in a closer vicinity to a liquid crystal cell, whereby the liquid crystal display can be rendered thin.

The protective film or the biaxial optical anisotropic substance sheet can be adhered to the light incident side polarizer and/or the light emission side polarizer by means of adhesion usually using an adhesive or a pressure-sensitive adhesive. The adhesive and pressure-sensitive adhesive include, for example, those which are made of acrylic, silicone, polyester, polyurethane, polyether or rubbery adhesive or pressure-sensitive adhesive. Of these, acrylic adhesive and pressure-sensitive adhesive are preferable of high heat resistance and high transparency.

For the adhesion of the polarizers to the biaxial optical anisotropic substance sheet or the protective film, there can be adopted, for example, a procedure of cutting each of the polarizers and the biaxial optical aniactropic substance sheet or the protective film into a desired size, and superposing and adhering together the cut polarizers and biaxial optical anisotropic substance sheet or protective film; and a procedure of adhering together an each continuous polarizer and a continuous biaxial optical anisotropic substance sheet or protective film by roll-to-roll means.

The light emission side polarizing sheet used in the present invention is provided with a low refractive index layer comprising an aerogel and having a refractive index of not larger than 1.37, laminated on a light emission side of the light emission side polarizing sheet. Preferably, the light emission side polarizing sheet has a hard coat layer and the low refractive index layer, formed in this order on the light emission surface of the light emission side polarizing sheet. Usually the light emission side polarizer preferably has a protective film adhered onto the light emission side, and a hard coat layer and the low refractive index layer are formed the light emission surface of the protective film.

By forming the hard coat layer and the low refractive index layer in this order on the light emission surface of the protective film laminated on the light emission side of the light emission side polarizer, the liquid crystal display unit exhibits no or more minimized undesirable mirroring of outer images.

By forming the low refractive index layer on the light emission side of the light emission side polarizer, the liquid crystal display units gives exhibits good qualified images with a high contrast. By forming a hard coat layer in addition to the low refractive index layer on the light emission side of the light emission side polarizer, the liquid crystal display unit has an enhanced abrasive resistance, and exhibits more improved contrast.

The hard coat layer is a layer having a high surface hardness. More specifically, it refers to a layer having a hardness of at least HB as determined by the pencil hardness testing method according to JIS K 5600-5-4.

The average thickness of the hard coat layer is not particularly limited, but is usually in the range of 0.5 to 30 μm, preferably 3 to 15 μm.

A material used for forming the hard coat layer is not particularly limited provided that it is capable of forming a hard coat layer having a hardness of at least HE as expressed by the pencil hardness determined according to JIS K 5600-5-4. Such material includes, for example, organic hard coat materials such as silicone material, melamine material, epoxy material, acrylic material and urethane acrylate material; and inorganic hard coat materials such as silicon dioxide. Of these, urethane acrylate material and polyfunctional acrylate material are preferable because of high adhesion force and enhanced productivity.

The hard coat layer usually has a refractive index of larger than 1.37, preferably at least 1.55 and more preferably at least 1.60. When the refractive index of the hard coat layer is high, the abrasion resistance is enhanced, and the antireflection function becomes high in a wideband region over the entire visible light region, and the designing and formulation of the low refractive index layer to be formed thereon can be easy. The refractive index can be determined, for example, by using a conventional spectroscopic ellipsometer.

Preferably the hard coat layer further contains inorganic oxide particles. By the incorporation of inorganic oxide particles, the hard coat layer can have more enhanced abrasion resistance and a hard coat layer having a refractive index of at least 1.33, preferably at least 1.55 can be easily obtained. The inorganic oxide particles used preferably have a high refractive index, more specifically, a refractive index of at least 1.6, preferably in the range of 1.6 to 2.3. As specific examples of such inorganic particles having a high refractive index, there can be mentioned titania (titanium oxide), zirconia (zirconium oxide), zinc oxide, tin oxide, cerium oxide, antimony pentoxide, antimony-doped tin oxide (ATO), phosphorus-doped tin oxide (PTO), fluorine-doped tin oxide (FTO), tin-doped indium oxide (ITO), zinc-doped indium oxide (IZO) and aluminum-doped zinc oxide (AZO). Of these, antimony pentoxide is preferably used because it has a high refractive index and well balanced electrical conductivity and transparency, and therefore is suitable as material for adjusting refractive index.

The hard coat layer can be formed by a process wherein the protective film on the polarizing sheet is coated with a composition comprising the above-mentioned hard coat layer-forming material and optional inorganic oxide particles; and, if desired, the liquid coating is dried and then hardened, Prior to the coating of the hard coat layer-forming material-containing composition, the surface of the protective layer can be subjected to, a plasma treatment or primer treatment to enhance the peeling strength between the hard coat layer and the protective film. The method of hardening the coating includes a heat hardening method and an ultraviolet ray hardening method. Of these, an ultraviolet ray hardening method is preferable.

A resin forming the protective layer and a resin forming the hard coat layer can be co-extruded to form a co-extrusion resin film having a laminate structure comprised of a hard coat layer and a protective layer.

The hard coat layer may have microscopic roughness formed on the surface thereof, to prevent the glare of light. The configuration of the microscopic roughness is not particularly limited and may be similar to the conventional microscopic roughness employed for prevention of the glare of light.

The low refractive index layer is a layer having a refractive index of not larger than 1.37. The lower the refractive index, the more preferable the liquid crystal device unit. Usually the refractive index is in the range of 1.25 to 1.37, and especially preferably 1.32 to 1.36. By imparting the desired low refractive index to the low refractive index layer, a liquid display device unit having good and well balanced visibility, abrasion resistance and mechanical strength. The low refractive index layer usually has a thickness in the range of 10 to 1,000 nm.

As the material for forming the low refractive index layer, aerogel is preferably used. Aerogel is a transparent porous material having fine bubbles dispersed in a matrix thereof. The most part of the bubbles have a diameter of not larger than 200 nm. The matrix as used herein refers to a material capable of forming a film on the light-emitting side of the light-emitting side polarizing sheet. The content of bubbles in the aerogel is preferably in the range of 10 to 60% by volume, more preferably 20 to 40% by volume.

The aerogel includes, for example, silica aerogel, and a porous material having hollow particles dispersed in a matrix.

The aerogel used preferably such that the refractive index n_{L} of the resulting low refractive index layer satisfies the following formulae [1] and [3],

n_{L}≦1.37 Formula [1]

(n_{H})^{1/2}−0.2≦n_{L}≦(n_{E})^{1/2}+0.2 Formula [3]

wherein n_{z} is a refractive index of the hard coat layer. Preferably the refractive index n_{L} of the low refractive index layer satisfies the following formulae [4] and [6],

1.25≦n_{L}≦1.35 Formula [4]

(n_{H})^{1/2}−0.15≦n_{L}<(n_{H})^{1/2}+0.15 Formula [6]

The low refractive index layer may be composed of a single layer or a multilayer. In the case when the low refractive index layer is composed of a multilayer, the layer of the multilayer adjacent or the most closest to the hard coat layer should have a refractive index n_{L} satisfying the above-mentioned formulae.

The low refractive index layer is preferably a cured film selected from the following [I], [II] and [III].

[I] A cured film formed from a coating material composition comprising:

(i) fine hollow particles having a shell comprised of a metal oxide,

(ii) at least one hydrolysis product selected from:

(ii-1) a hydrolysis product (A) obtained by hydrolysis of a hydrolyzable organosilane represented by the following general formula (1)

SiX₄

where X is a hydrolyzable group, and

(ii-2) a copolymerization-hydrolysis product (B) obtained by hydrolysis and copolymerization of a hydrolyzable organosilane represented by the formula (1) with a hydrolyzable organosilane having a fluorine-substituted alkyl group or groups; and

(iii) a hydrolyzable organosilane (C) having water-repellent groups in its straight-chain structure, and having at least two silicon atoms in the molecule, each of which is bonded with an alkoxy group or alkoxy groups

[II] A cured film formed from a coating material composition comprising:

(i) fine hollow particles having a shell comprised of a metal oxide,

(ii) at least one hydrolysis product selected from:

(ii-1) a hydrolysis product (A) obtained by hydrolysis of a hydrolyzable organosilane represented by the following general formula (1);

SiX₄

where X is a hydrolyzable group, and

(ii-2) a copolymerization-hydrolysis product (B) obtained by hydrolysis and copolymerization of a hydrolyzable organosilane represented by the formula (1) with a hydrolyzable organosilane having a fluorine-substituted alkyl group or groups; and

(iii) a dimethyl-type silicone diol (D) represented by the following general formula (4):

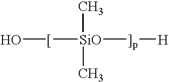

where p is a positive integer.

[III] A cured film formed from a coating material composition comprising;

(i) a re-hydrolyzed product obtained by subjecting a mixture comprising fine hollow particles having a shell comprised of a metal oxide, and a hydrolysis product (A) obtained by hydrolysis of a hydrolyzable organosilane represented by the following general formula (1):

SiX₄

where X is a hydrolyzable group, to a hydrolysis treatment whereby the hydrolysis product (A) is re-hydrolyzed; and

(ii) a copolymerization-hydrolysis product (B) obtained by hydrolysis and copolymerization of a hydrolyzable organosilane represented by the formula (1) with a hydrolyzable organosilane having a fluorine-substituted alkyl group or groups.

The coating material compositions used for forming the above-mentioned cured films [I], [II] and [III] constituting preferable low refractive index layers will be specifically described.

The coating material composition used for forming the cured film [1] comprises (ii) at least one hydrolysis product selected from the hydrolysis product (A) and the copolyaerization-hydrolysis product (B), and (iii) the hydrolyzable organosilane (C). Thus, the coating material composition includes a combination of the hydrolysis product (A) with the hydrolyzable organosilane (C), a combination of the copolymerization hydrolysis product (B) with the hydrolyzable organosilane (C), and a combination of the hydrolysis product (A), the copolymerization-hydrolysis product (B) with the hydrolyzable organosilane (C).

The hydrolysis product (A) is a tetratunctional hydrolysis product (tetrafunctional silicone resin) obtained by hydrolysis of a tetrafunctional hydrolyzable organosilane represented by the following general formula (1):

SiX₄

where X is a hydrolyzable group. A preferable example of the tetrafunctional hydrolyzable organosilane is a tetrafunctional organoalkoxysilane represented by the following general formula (5):

Si(OR)₄

where R in the group of OR is a univalent hydrocarbon group. The univalent hydrocarbon group is not particularly limited, but preferably has 1 to 8 carbon atoms, and includes, for exampler alkyl groups such as methyl, ethyl, propyl, butyl, pentyl, hexyl, heptyl and octyl groups. The CA group preferably includes alkoxy groups containing the above-recited alkyl groups R. Among the alkoxy groups, those which have at least 3 carbon atoms in each alkoxy group may be either linear chain-like such as n-propyl group and n-butyl group, or branched such as isopropyl group, isobutyl group and t-butyl group.

The hydrolyzable group X in the tetrafunctional hydrolysable organosilane includes, in addition to the above-recited alkoxy groups, an acetoxy group, an oxime group (—O—N═C—R(R′)), an enoxy group (—O—C(R)═C (R′) R″), an amino group, an aminoxy group (—O—N(R)R′) and an amide group (—N(R)—C(═O)—R′) (in these groups, R, R′ and R″ independently represent, for example, a hydrogen atom or a univalent hydrocarbon group), and halogens such as chlorine and bromine.

The tetrafunctional silicone resin, i.e., the hydrolysis product (A) is prepared by hydrolyzing a tetrafunctional hydrolysable organosilane such as the above-mentioned organoalkoxy silane (the hydrolysis may be either completely or partially conducted). The molecular weight of the resulting tetrafunctional silicone resin (the hydrolysis product (A)) is not particularly limited, but the weight average molecular weight thereof is preferably in the range of 200 to 2,000, because a cured film having high mechanical strength can be obtained with a relatively small amount of a matrix-forming material to the amount of fine hollow particles such as fine hollow silica particles. When the weight average molecular weight is smaller than 200, the film-forming property tends to be poor, In contrast, when the weight average molecular weight exceeds 2,000, the cured film tends to have poor mechanical strength.

The complete or partial hydrolysis of the tetrafunctional hydrolysable organosilane of the formula SiX₄ (X═OR where R is a univalent hydrocarbon group, preferably an alkyl group) such as tetraalkoxy silane is carried out in the presence of water in an amount such that the molar ratio [H₂O]/[OR] is at least 1.0, usually in the range of 1.0 to 5.0 and preferably 1.0 to 3.0, and further preferably in the presence of an acid or base catalyst. Especially a partial or complete hydrolysis product obtained by the hydrolysis carried out in the presence of an acid catalyst is characterized in that a planar crosslinked structure is readily formed, and gives a dried cured film having an enhanced porosity. When the molar ratio [H₂O]/[OR] is smaller than 1.0, the amount of unreacted alkoxy group becomes large, and a resulting cured film is liable to have a large refractive index. In contrast, when the molar ratio is larger than about 5.00 the rate of condensation reaction becomes rapid, a resulting coating material composition is occasionally gelled.

The conditions of hydrolysis may be appropriately chosen. For example, the above-mentioned materials can be mixed together and stirred for hydrolysis at a temperature of 5° C. to 30° C. for a period of 10 minutes to 2 hours. To obtain a hydrolyzed product having a molecular weight of at least 2,000 to give a matrix having a more reduced refractive index, the desired tetrafunctional silicone resin can be obtained by carrying out the hydrolysis reaction, for example, at a temperature of 40° C. to 100° C. for a period of 2 to 100 hours.

The copolymerization-hydrolysis product (B) is a copolymerized and hydrolyzed product obtained by hydrolysis and copolymerization of a hydrolyzable organosilane with a hydrolyzable organosilane having a fluorine-substituted alkyl group or groups;

The hydrolyzable organosilane used is a tetrafunctional hydrolysable organosilane represented by the above-mentioned formula (1), which preferably includes a tetravalent organoalkoxy silane represented by the above-mentioned formula (5).

As preferable examples of the hydrolyzable organosilane having a fluorine-substituted alkyl group or groups, those which have structural units represented by the following general formulae (7) to (9) are mentioned.

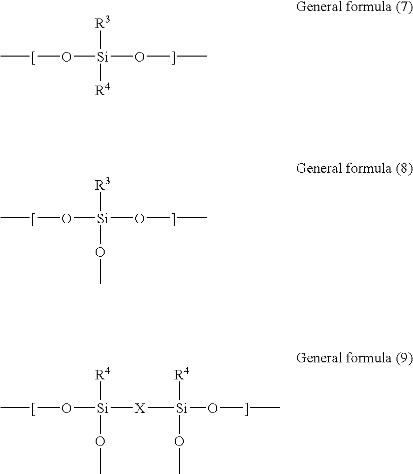

In the formulae (7) to (9), R³ represents a fluoroalkyl group having 1 to 16 carbon atoms or a perfluoroalkyl group having 1 to 16 carbon atoms, and R⁴ represents an alkyl, halogenated alkyl, aryl, alkylaryl, arylalkyl, alkenyl or alkoxy group, which has 1 to 16 carbon atoms; or a hydrogen or halogen atom; X represents —CₐH_{b}F_{c}—; a is an integer of 1 to 12, (b+c) is equal to 2a, b is an integer of 0 to 24, and c is an integer of 0 to 24. X preferably includes those which have a fluoroalkylene group or an alkylene group.

The copolymerization-hydrolysis product (1) is obtained by mixing together and copolymerizing the hydrolyzable organosilane with the hydrolyzable organosilane having a fluorine-substituted alkyl group or groups. The mixing ratio (copolymerization ratio) of the hydrolyzable organosilane to the hydrolyzable organosilane having a fluorine-substituted alkyl group or groups is not particularly limited, but, the ratio of the hydrolyzable organosilane to the hydrolyzable organosilane having a fluorine-substituted alkyl group or groups is preferably in the range of 99/1 to 50/50 as expressed by mass of the condensed compound. The weight average molecular weight of the copolymerization-hydrolysis product (B) is not particularly limited, but is preferably in the range of 200 to 5,000. When the weight average molecular weight is smaller than 200, the film-forming property becomes poor. In contrast, when the weight average molecular weight is larger than 5,000, a resulting cured film is liable to have poor mechanical strength.

The hydrolyzable organosilane (C) used in the present invention has water-repellent (i.e., hydrophobic) groups in its straight-chain structure, and has at least two silicon atoms in the molecule, each of which is bonded with an alkoxy group or alkoxy groups. This silicone alkoxide is preferably bonded to both ends of the straight chain structure. The hydrolyzable organosilane (C) has two or more silicone alkoxides, and the number of upper limit of silicone alkoxide is not particularly limited.

The hydrolyzable organosilane (C) includes two types of organosiloxanes, one of which has a dialkylsiloxy straight chain structure and the other of which has a fluorine-containing straight chain structure.

The hydrolyzable organosilane (C) having a dialkylsiloxy straight chain structure has a structural unit represented by the following general formula (2):

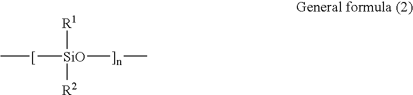

where R¹ and R² represents an alkyl group. The dialkylsiloxy straight chain structure preferably has a length such that n in the formula (2) is an integer of 2 to 200. When the integer n is 1, the dialkylsiloxy straight chain structure exhibits poor water repellency, and thus the effect of the hydrolyzable organosilane (C) having a dialkylsiloxy straight chain structure is not sufficiently manifested. In contrast, when the integer n is larger than 200, the hydrolyzable organosilane (C) tends to exhibit poor miscibility with other matrix-forming material, and a resulting cured film occasionally has poor transparency and poor uniformity in appearance.

The hydrolyzable organosilane (C) having a dialkylsiloxy straight chain structure includes, for example, hydrolyzable organosilanes represented by the following formulae (6), (11) and (12).

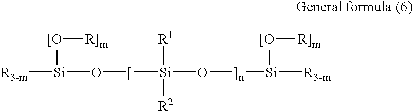

where R¹, R² and R represent an alkyl group, and n is an integer of 1 to 3.

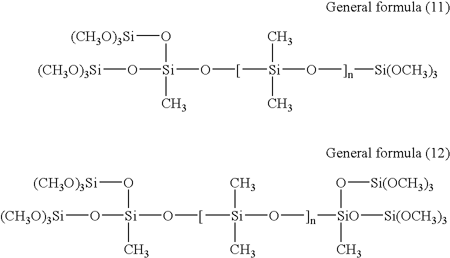

The hydrolyzable organosilane of the formula (6) is not particularly limited, but, a specific example thereof is represented by the following formula (10).

General formula (10):

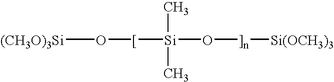

The hydrolyzable organosilane (C) having a fluorine-containing straight chain structure has a structural unit represented by the following general formula (3);

—[—CF₂—]ₘ—

The fluorine-containing straight chain structure preferably has a length such that m in the formula (3) is an integer of 2 to 20. When the integer m is 1, the straight chain structure exhibits poor water repellency, and thus the effect of the hydrolyzable organosilane (C) having a fluorine-containing straight chain structure is not sufficiently manifested. In contrast, when the integer m is larger than 20, the hydrolyzable organosilane (C) tends to exhibit poor miscibility with other matrix-forming material, and a resulting cured film occasionally has poor transparency and poor uniformity in appearance.

The hydrolyzable organosilane (C) is not particularly limited, and, as specific examples thereof, those which are represented by the following formulae (13) through (16) can be mentioned.

(CH₃O)₃Si—(CH₂)₂—(CF₂)₂—(CH₂)₂—Sl(OCH₃)₃ General formula (13)

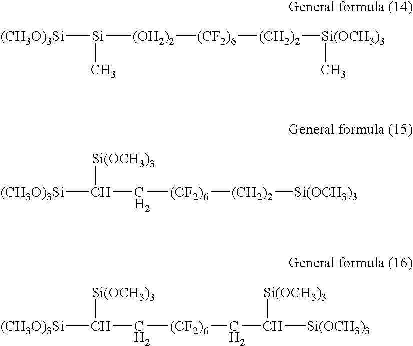

Of the above-mentioned hydrolyzable organosilanes (C) having a fluorine-containing straight chain structure, hydrolyzable organosilanes (C) having at least three silicon atoms having bonded thereto alkoxy groups, on the straight chain structure such as those of formulae (15) and (16), are especially preferable. By at least three silicon atoms having bonded thereto alkoxy groups, on the straight chain structure, the water-repellent straight-chain structure is more firmly bonded to the surface of a cured film, therefore, the surface of cured film exhibits more enhanced water-repellency.

The matrix-forming material in the coating material composition for cured film [I] is formed by mixing together at least one of the above-mentioned hydrolysis product (A) and copolymerization-hydrolysis product (B) with the hydrolysable organosilane (C). The mixing ratio of at least one of the hydrolysis product (A) and the copolymerization-hydrolysis product (B) to the hydrolysable organosilane (C) is not particularly limited, but, the ratio of [at least one of (A) and (B)] is preferably in the range of 99/1 to 50/50 by mass as expressed by the condensed compound.

The fine hollow particles having a shell comprised of a metal oxide, as used in the present invention, preferably includes fine hollow silica particles. The fine hollow silica particles are not particularly limited, provided that they have a structure such that each particle has a void within a shell comprising silica. The fine hollow silica particles as used herein refer to those which have a shell comprised of (i) a single silica layer, (ii) a single composite oxide layer which is composed of silica and an inorganic oxide other than silica, and (iii) a double layer comprised of the above-mentioned layers (i) and (ii). The shell may be a porous body having pores, and the pores may be closed by the procedures mentioned below to close the void inside each particle. A preferable shell is a double layer comprised of a first silica shell layer (inner silica shell layer) and a second silica shell layer (outer silica shell layer). By the provision of the second silica shell layer, the pores in the shell can be clogged to form a densified shell and to close the void inside each particle.

The first silica shell layer preferably has a thickness in the range of 1 to 50 nm, especially preferably 5 to 20 nm. When the thickness of the first silica shell layer is smaller than 1 nm, it is often difficult to keep the shape of particle, and also difficult to give a stable fine hollow silica particle. Further, when the second silica shell layer is formed on the first silica shell layer, partially hydrolyzed product of an organic silicon compound tends to intrude into pores in a particle core and the particle core-constituting ingredient becomes difficult to remove. In contrast, when the thickness of the first silica shell layer is larger than 50 nm, the proportion of the void in the fine hollow silica particle is reduced and the refractive index often becomes difficult to lower to the desired extent.

The thickness of the shell is preferably in the range of 1/50 to ⅕ of the average particle diameter. The thickness of the second silica shell layer is preferably chosen so that the total thickness of the first silica shell layer and the second silica shell layer is in the range of 1 to 50 nm, especially preferably 20 to 49 cm to form a sufficiently densified shell.

The voids within the fine hollow silica particles are occupied by a solvent used for the preparation of the fine hollow silica particles and/or a gas intruding therein at drying step. Further, a precursor substance used for forming the voids may remain within the voids. In some cases, a small amount of the precursor substance remains in the voids in the state adhering onto the inner surface of shell, and, in the other cases, a large amount of the precursor substance occupies the predominant part of the voids.

The precursor substance used refers to a porous material which remains when a part of the ingredients constituting nucleus particles for forming the first silica shell layer is removed. The nucleus particles are porous composite oxide particles comprised of silica and an inorganic oxide other than silica. As specific examples of the inorganic oxide, there can be mentioned Al₂O₃, T₂O₃, TiO₂, ZrO₂, Sn₂, Ce₂O₃, P₂O₅, Sb₂O₃, MoO₃, ZnO₂ and WO₃. These inorganic oxides may be used either alone or as a combination of at least two thereof. The combination of at least two inorganic oxides include, for example, TiO₂—Al₂O₃ and TiO₂—ZrO₂.

The pores of the porous material for the precursor substance are also occupied by the above-mentioned solvent and/or gas. In the case when a large amount of the ingredients constituting the nucleus particles are removed, the volume of the voids increases to give fine hollow silica particles exhibiting a low refractive index. A transparent cured film prepared from a composition comprising the fine hollow silica particles exhibits a low refractive index and an enhanced antireflection performance.

The coating material composition used in the present invention can be prepared by mixing together the above-mentioned matrix-forming material with the fine hollow particles. The proportion of the fine hollow particles to the other ingredients is not particularly limited, but the ratio of the fine hollow particles/the other ingredients as solid matter is preferably in the range of 90/10 to 25/75 by weight, more preferably 75/25 to 35/65 by weight. The ratio of the fine hollow particles exceeds 90/10 by weight, a cured film made from the coating material composition is liable to have poor mechanical strength. In contrast, the ratio of the fine hollow particles is smaller than 25/75 by weight, a cured film made from the coating material composition is liable to have an insufficiently reduced refractive index.

The coating material composition may have incorporated therein fine silica particles each having no void within a shell, in addition to the above-mentioned fine hollow silica particles. In the case when the fine silica particles having no void are incorporated, a cured film having enhanced mechanical strength, improved surface smoothness and enhanced crack resistance can be obtained. The shape of the fine silica particles having no void is not particularly limited, and, may be either powdery or sol-like. In the case when the fine silica particles having no void is sol, i.e., a colloidal silica, the sol is not particularly limited and may be either colloidal silica dispersed in Water or colloidal silica dispersed in a hydrophilic organic solvent. In general, the colloidal silica comprises 20% to 50% by mass of silica as solid matter. Based on this solid silica content, the amount of silica used can be determined. The amount of the fine silica particles having no void is preferably in the range of 0.1% to 30% by mass based on the weight of the total solid content in the coating material composition. When the amount of the fine silica particles having no void is smaller than 0.1% by mass, the effect of the fine silica particles having no void is not sufficiently manifested. In contrast, when the amount of the fine silica particles having no void exceeds 30% by mass, a cured film has not sufficiently reduced refractive index.

The coating material composition for forming the cured film [II] comprises (i) fine hollow particles having a shell comprised of a metal oxide, (ii) at least one hydrolysis product selected from the hydrolysis product (A), mentioned below, and the hydrolysis product (B), mentioned below, and (iii) the dimethyl-type silicone diol (D), mentioned below. Thus, the coating material composition comprises a combination of the hydrolysis product (A) with the dimethyl-type silicone diol (D), a combination of the hydrolysis product (B) with the dimethyl-type silicone diol (D), or a combination of the hydrolysis product (A) and the hydrolysis product (B) with the dimethyl-type silicone diol (D).

The hydrolysis product (A) and the hydrolysis product (B) can be selected from the hydrolysis product (A) and the hydrolysis product (B), respectively, which are used for the above-mentioned coating material composition for forming the cured film [I].

The dimethyl-type silicone diol (D) is a silicone diol of the dimethyl-type represented by the above mentioned formula (4). In the above-mentioned formula (4), the number “p” of the repeating structural unit of dimethylsiloxane is not particularly limited, but is preferably in the range of 20 to 100. When the number “p” is smaller than 20, the effect of reducing the frictional resistance cannot be manifested to the desired extent, as mentioned below. In contrast, when the number “p” is larger than 200, the dimethyl-type silicone dice (D) tends to have poor miscibility with the other matrix material, and a resulting cured film is liable to have reduced transparency and poor uniformity in appearance.

In the coating material composition comprising at least one of the hydrolysis product (A) and the hydrolysis product (B), and the silicone diol (D), the amount of the silicone diol (D) is not particularly limited, but is preferably in the range of 1 to 10% by mass based on the total solid content (which includes the sum of the fine hollow particles having a shell comprised of a metal oxide and the solid matter of the condensed product of the matrix-forming material) of the coating material composition.

The coating material composition used for forming the cured film [II] on the surface of a substrate film comprises the silicone diol as a part of the matrix-forming material, and, the cured film [II] containing the silicone diol exhibits a lowered frictional resistance. Thus, the surface of the cured film is smooth and is not readily marred, and exhibits an enhanced abrasion resistance. Especially the dimethyl-type silicone diol tends to be exposed on the surface of the cured film, and does not badly influence or influences only to a minimized extent the transparency of the cured film (that is, the haze value is very small).

The dimethyl-type silicone did has a high miscibility with the other matrix material used in the present invention, and has reactivity with a silanol group in the matrix material and thus is readily fixed as a part of the matrix material on the surface of the cured film. This characteristic makes a striking contrast to that of conventional silicone oil further having methyl groups at both ends of the molecule chain, which is readily removed from the cured film surface when it is wiped. The cured film according to the present invention exhibits a reduced frictional resistance over a long period and its abrasion resistance is durable for a long period.

The coating material composition for forming the cured film [III] comprises (i) a re-hydrolyzed product obtained by subjecting a mixture of the hydrolysis product (A), mentioned below, with fine hollow particles having a shell comprised of a metal oxide, to a hydrolysis treatment whereby the hydrolysis product (A) is re-hydrolyzed; and (ii) a copolymerization-hydrolysis product (B), mentioned below. The hydrolysis product (A) is a hydrolysis product obtained by hydrolysis of a hydrolyzable organosilane represented by the following general formula (1):

SiX₄

where X is a hydrolyzable group. The copolymerization-hydrolysis product (B) is obtained by hydrolysis and copolymerization of a hydrolyzable organosilane represented by the formula (1) with a hydrolyzable organosilane having a fluorine-substituted alkyl group or groups.

In other words, the above-mentioned coating material composition comprises fine hollow metal oxide particles and a matrix-forming material which comprises a re-hydrolyzed product (A) and the copolymerization-hydrolysis product (B).

The hydrolysis product (A) can be the same as the hydrolysis product (A) used for the above-mentioned coating material composition for forming the cured film [1].

The hydrolysis product (A)-containing re-hydrolyzed product as used herein is obtained by subjecting a mixture of the hydrolysis product (A) with fine hollow particles having a shell comprised of a metal oxide, to a hydrolysis treatment whereby the hydrolysis product (A) is re-hydrolyzed. When the mixture of the hydrolysis product (A) with fine hollow particles having a shell comprised of a metal oxide, to a hydrolysis treatment, the hydrolysis product (A) is reacted with the surface of the fine hollow metal oxide particles to form a chemical bond with the result of enhancing the miscibility of the hydrolysis product (A) with the fine hollow metal oxide particles.

The hydrolysis treatment of the mixture of the hydrolysis product (A) with the fine hollow metal oxide particles is preferably carried out at room temperature, i.e., a temperature of approximately 20 to 30° C. when the temperature for hydrolysis is too low, the hydrolysis reaction does not proceed to a desired extent and the effect of enhancing the miscibility is insufficient. In contrast, when the temperature for hydrolysis is too high, the rate of hydrolysis reaction is too high, therefore, the molecular weight becomes difficult to control to a uniform value and the molecular weight becomes too large to obtain a cured film of the desired high strength.

As a modification of the hydrolysis treatment of the mixture of the hydrolysis product (A) with the fine hollow metal oxide particles, a hydrolysis treatment of a mixture of a hydrolyzable organosilane with the fine hollow metal oxide particles can be conducted to give a hydrolysis product (A) as well as a re-hydrolyzed product comprising a re-hydrolyzed product (A) with the fine hollow metal oxide particles.

The copolymerization-hydrolysis product (B) can be the same as the copolymerization-hydrolysis product (B) used for the above-mentioned coating material composition for forming the cured film [I].

The coating material composition for forming the cured film [III] can be said as comprising a matrix-forming material which is a mixture comprised of the re-hydrolyzed product (A) with the copolymerization-hydrolysis product (B), and a filler comprised of the fine hollow metal oxide particles. This coating material composition can be prepared by mixing together (i) the hydrolysis product (A)-containing re-hydrolyzed product (which is a mixture of re-hydrolyzed product (A) with the fine hollow metal oxide particles) with (ii) the copolymerization-hydrolysis product (B). The mixing ratio of the hydrolysis product (A)-containing re-hydrolyzed product to the copolymerization-hydrolysis product (B) is preferably in the range of 99/1 to 50/50 by mass. When the proportion of the copolymerization-hydrolysis product (B) is smaller than 1% by mass, the water repellency and oil repellency and the antifouling property cannot be sufficiently manifested. In contrast, when the proportion of the copolymerization-hydrolysis product (B) exceeds 50% by mass, the beneficial tendency of surface-exposition, mentioned below, of a layer of the copolymerization-hydrolysis product (B) above the layer of the hydrolysis product (A)-containing re-hydrolyzed product is reduced, and there is no great difference between the mixture of the hydrolysis product (A)-containing re-hydrolyzed product with the copolymerization-hydrolysis product (B), and a mixture of the hydrolysis product (A) with the copolymerization-hydrolysis product (B).

By subjecting a mixture of the hydrolysis product (A) with the fine hollow metal oxide particles to a hydrolysis treatment to re-hydrolyze the hydrolysis product (A), the affinity of the hydrolysis product (A) to the fine hollow metal oxide particles can be enhanced, and, when a substrate film is coated with the coating material composition comprising the hydrolysis product (A)-containing re-hydrolyzed product and the copolymerization-hydrolysis product (B) to form a coating film, there is a beneficial tendency of surface-exposition of a layer of the copolymerization-hydrolysis product (B) above the layer of the hydrolysis product (A)-containing re-hydrolyzed product.

The reason for which the above-mentioned beneficial tendency of the copolymerization-hydrolysis product (3) existing on the surface layer of a film is not clear, but it is presumed that the hydrolysis product (A) exhibits enhanced affinity to the fine hollow metal oxide particles and is uniformly distributed in the film, whereas the copolymerization-hydrolysis product (3) does not exhibit good affinity to the fine hollow metal oxide particles and, when a substrate film is coated with the coating material composition comprising the hydrolysis product (A)-containing re-hydrolyzed product and the copolymerization-hydrolysis product (5) to form a coating film, the copolymerization-hydrolysis product (B) is liable to form a surface layer on the film to be thereby exposed on the surface of film. Especially when glass sheet is used as a substrate film, the glass sheet has poor affinity to the copolymerization-hydrolysis product and therefore the tendency of the copolymerization-hydrolysis product (B) forming a surface layer on the coating film becomes more marked. When the coating film having a surface layer is cured, the resulting cured film having the surface layer of the fluorine-containing copolymerization-hydrolysis product (A) exhibits high water repellency and high oil repellency and improved antifouling property due to the fluorine ingredients located on the surface layer of cured film.

Instead of or in addition to the fine hollow particles having a shell comprised of a metal oxide, which is incorporated in the coating material composition for forming the cured film for a low refractive index layer, the following porous particles can be used.

The porous particles used instead of or in addition to the fine hollow metal oxide particles include, for example, silica aerogal particles, composite aerogel particles such as silica/alumina aerogel particles, and organic aerogel particles such as melamine aerogel particles.

As specific and preferable examples of the porous particles, there can be mentioned:

(a) porous particles, which are prepared by subjecting a mixture comprising an alkyl silicate, a solvent, water and a catalyst for hydrolysis and polymerization, to a hydrolysis-polymerization whereby the alkyl silicate is hydrolyzed and polymerized; and then, removing the solvent by drying the hydrolysis-polymerization product; and/or

(b) porous particles having a cohesion average particle diameter in the range of 10 nm to 100 nm, which are prepared by subjecting a mixture comprising an alkyl silicate, a solvent, water and a catalyst for hydrolysis and polymerization, to a hydrolysis-polymerization whereby the alkyl silicate is hydrolyzed and polymerized; terminating polymerization before the polymerization mixture is gelled to give a stabilized organosilica sol; and then removing the solvent by drying the organosilica sol.

The above-mentioned porous particles may be used either alone or as a combination of at least two thereof.

The above-mentioned porous particles (a), which are prepared by hydrolysis-polymerization of alkyl silicate followed by drying for removal of solvent, are prepared by subjecting a mixture comprising an alkyl silicate (which is also be called as alkoxysilane or silicon alkoxide), a solvent, water and a catalyst for hydrolysis and polymerization, to a hydrolysis-polymerization whereby the alkyl silicate is hydrolyzed and polymerized; and then, removing the solvent by drying the hydrolysis-polymerization product, as described in U.S. Pat. Nos. 4,402,827, 4,432,956 and 4,610,863.

The drying of the hydrolysis-polymerization product is preferably carried out by a supercritical drying method. More specifically, an alkoxysilane is hydrolyzed and polymerized to give a gel-like compound having a silica backbone in a wet state, and the gel-like compound is dried in a solvent (i.e., dispersion medium) such as an alcohol or liquefied carbon dioxide in a supercritical state exceeding the critical point. The drying in a supercritical state can be carried out, for example, by immersing the wet gel-like compound in liquefied carbon dioxide whereby a part or the whole of the solvent contained in the wet gel-like compound is substituted by liquefied carbon dioxide having a critical point lower than that of the solvent, and then, the gel-like compound is dried in a single medium comprised of carbon dioxide or a mixed medium comprised of carbon dioxide and a solvent under supercritical conditions,

As described in JP-A H5-279011 and JP-A H7-138375, the wet gel-like compound produced by hydrolyzing and polymerizing an alkoxysilane in the above-mentioned processes are preferably treated so as to render hydrophobic the wet gel-like compound. The thus produced hydrophobic silica aerogel is characterized in that moisture or water does not easily penetrate into the silica aero gel and therefore the refractive index and light transmittance of silica aerogel are not deteriorated. The treatment for imparting a hydrophobic property to the silica aerogel can be conducted before or during the drying under supercritical conditions.

This treatment of imparting a hydrophobic property involves a reaction of hydroxyl groups in the silanol groups present on the surface of gel-like compound with functional groups of a hydrophobicity-imparting agent whereby the hydroxyl groups are substituted by the functional groups of the hydrophobicity-imparting agent. The procedure for hydrophobicity-imparting treatment comprises, for example, immersing the gel-like compound in a solution of the hydrophobicity-imparting agent in a solvent, and stirring the mixed solution so that the gel-like compound is impregnated with the hydrophobicity-imparting agent, and then, if desired the gel-like compound is heated, whereby a hydrophobicity-imparting reaction of substituting hydroxyl groups by hydrophobic functional groups is caused.

The solvent used for the hydrophobicity-imparting treatment includes, for example, methanol, ethanol, isopropanol, xylene, toluene, benzene, N,N-dimethylformamide and hexamethyldisiloxane. The solvent used in not particularly limited provided that the hydrophobicity-imparting agent is easily soluble in the solvent, and a solvent contained in the gel-like compound is capable of being substituted by the solvent.

The drying under supercritical conditions is carried out in a medium in which the supercritical drying can easily be effected, which includes, for example, methanol, ethanol, isopropanol and liquefied carbon dioxide, and those which are capable of being substituted by these solvents.

As specific examples of the hydrophobicity-imparting agent, there can be mentioned hexamethyldisilazane, hexamethyl-disiloxane, trimethylmethoxysilane, dimethyldimethoxysilane, methyltrimethoxysilane, ethyltrimethoxysilane, trimethyl-ethoxysilane, dimethyldiethoxysilane and methyltriethoxy-silane.

The silica aerogel particles can be prepared by pulverizing a dry bulk of silica aerogel. It is to be noted, however, that the cured film according to the present invention should have an antireflection performance, and therefore, the cured film should be thin, i.e., have a thickness of about 100 nm and thus the aerogel particles should have a particle diameter of about 50 nm. The aerogel particles having a particle diameter of about 50 nm are usually difficult to prepare. When aerogel particles having a larger particle diameter are used, a cured film having a uniform thickness and a reduced surface roughness smoothness is difficult to obtain.

Other preferable porous particles are porous particles (b) having a cohesion average particle diameter in the range of 10 nm to 100 nm, which are prepared by subjecting a mixture comprising an alkyl silicate, a solvent, water and a catalyst for hydrolysis and polymerization, to a hydrolysis-polymerization whereby the alkyl silicate is hydrolyzed and polymerized; terminating polymerization before the polymerization mixture is gelled to give a stabilized organosilica sol; and then removing the solvent by drying the organosilica sol.

The above-mentioned porous particles (b) include, for example, fine silica aerogel particles which are prepared by the following method. First, a mixture comprising an alkyl silicate, a solvent, water and a catalyst for hydrolysis and polymerization is subjected to a hydrolysis-polymerization whereby the alkyl silicate is hydrolyzed and polymerized to give an organosilica-sol. The solvent used includes, for example, alcohols such as methanol. The catalyst for hydrolysis and polymerization includes for example, ammonia. The organosilica-sol is diluted with the solvent or the pH of the organosilica-sol is adjusted, whereby the polymerization is terminated before the polymerization mixture is gelled. Thus a stabilized organosilica-sol having controlled polymer particle diameters is obtained.

Dilution of the organosilica-sol with the solvent to give the stabilized organosilica-sol can be carried out, for example, by using a solvent capable of easily and uniformly dissolving the organosilica sol, which is used for the preparation of the organosilica-sol and includes, for example, ethanol, 2-propanol or acetone, with a dilution ratio of at least 2/1. If the solvent used for the preparation of the organosilica-sol is an alcohol and the solvent used for dilution of the organosilica-sol is an alcohol, the two alcohols are not particularly limited, but preferably, the alcohol used for the dilution of the organosilica-sol has a carbon number more than that of the alcohol used for the preparation of the organosilica-sol. This is because the hydrolysis-polymerization reaction can be desirably controlled with a dilution of the organosilica-sol due to the substitution of the alcohol with fewer carbon atoms by the alcohol with more carbon atoms.

Adjustment of the pH of the organosilica-sol to give the stabilized organosilica-sol can be carried out, for example, by adding an acid, when the catalyst for hydrolysis and polymerization is an alkali, or adding an alkali, when the catalyst for hydrolysis and polymerization is an acid, to the organosilica-sol so as to convert the pH of the organosilica-sol to a weakly acidic value. A suitable weakly acidic value varies depending upon the kind of solvent and the amount of water, which are used for the preparation of the organosilica-sol, but a preferable pH value is in the range of 3 to 4. For example, when ammonia is used as a catalyst for hydrolysis and polymerization, nitric acid or hydrochloric acid is added to the organosilica-sol so as to adjust the pH value to a value in the range of 3 to 4. When nitric acid is used as a catalyst for hydrolysis and polymerization, a weak alkali such as ammonia or sodium hydrogen carbonate is added to the organosilica-sol so as to adjust the pH value to a value in the range of 3 to 4.

The method for preparing a stabilized organosilica-sol, including the above-mentioned dilution of the organosilica-sol with a solvent, or the above-mentioned pH-adjustment, is not particularly limited, but, a combination of the dilution of the organosilica-sol with a solvent, with the pH-adjustment is preferable.

When the organosilica-sol is diluted with a solvent or its pH value is adjusted to prepare a stabilized organosilica-sol, an organic silane compound such as hexamethyldisilazane or trimethylchlorosilane can be added to conduct a treatment for rendering hydrophobic the fine silica aerogel particles. By this hydrophobicity treatment, the hydrolysis-polymerization reaction can be more controlled.

By directly drying the organosilica-sol, fine porous silica aerogel particles can be obtained, The porous silica aerogel particles preferably have a cohesion average particle diameter in the range of 10 nm to 100 nm. If the cohesion average particle diameter of particles exceeds 100 nm, a cured film having a uniform thickness and a reduced surface roughness becomes difficult to obtain. In contrast, if the cohesion average particle diameter of particles is smaller than 10 nm, when the porous silica aerogel particles are mixed together with the matrix-forming material to prepare a coating material composition, the matrix-forming material tends to penetrate into the silica aerogel particles with the result that a resulting dry film has poor porosity.

In a specific and preferable method for drying the organosilica-sol to give fine porous silica aerogel particles, the organosilica-sol is filled in a high-pressure vessel and the solvent inside the porous silica aerogel particles is substituted by liquefied carbon dioxide, the content in the vessel is maintained at a temperature of at least 32° C. and a pressure of at least 8 MPa, and then the inner pressure is reduced.

Another method of controlling the growth by polymerization of the organosilica-sol (other than the above-mentioned dilution method using a solvent or the above-mentioned pH adjustment method) includes, for example, addition of an organic silane compound such as hexamethyldisilazane or trimethylchlorosilane to stop the polymerization reaction. This method of adding an organic silane compound is beneficial especially in that the control of the growth by polymerization of the organosilica-sol and the hydrophocity treatment for rendering the organosilica-sol hydrophobic can be simultaneously attained.

When the cured film having an antireflection performance is formed according to the present invention, a high transparency (specifically a haze value of 0.2% or lower) is required. For satisfying this requirement, the silica aerogel particles are preferably added in the form of a uniform dispersion in a solvent to the matrix-forming material to prepare the coating material composition. More specifically, an alkyl silicate is first mixed with a solvent such as methanol, water, and an alkaline catalyst for hydrolysis and polymerization, and the mixture is subjected to hydrolysis-polymerization treatment whereby the alkyl silicate is hydrolyzed and polymerized to give an organosilica-sol. Then, before the organosilica-sol becomes gel, the organosilica-sol is diluted with a solvent or the pH value of the organosilica-sol is adjusted, as mentioned above, whereby the growth of the organosilica-sol particles is controlled and the organosilica-sol is stabilized. The thus-stabilized organosilica-sol can be added as a silica aerogel dispersion to the matrix-forming material to prepare the coating material composition used in the present invention.

The low refractive index layer used in the present invention preferably has a thickness in the range of 10 to 1,000 nm, preferably 30 to 500 nm. The low refractive index layer is comprised of at least one layer as mentioned above, and it may be comprised of two or more layers.

The protective film for a light emission side polarizing sheet usually exhibits a reflectivity of not larger than 1.4%, preferably not larger than 1.3%, as the maximum reflectivity as measured at an incident angle of 5° and a wavelength of 430 to 700 nm. More specifically, the protective film usually exhibits a reflectivity of not larger than 0.7%, preferably not larger than 0.6%, as measured at an incident angle of 5° and a wavelength of 550 nm. The protective film usually exhibits a reflectivity of not larger than 1.5%, preferably not larger than 1.4%, as the maximum reflectivity as measured at an incident angle of 20° and a wavelength of 430 to 700 nm. More specifically, the protective film usually exhibits a reflectivity of not larger than 0.9%, preferably not larger than 0.8%, as measured at an incident angle of 20° and a wavelength of 550 nm. When the protective film has the above-mentioned reflectivity, the glare of light and undesirable mirroring of outer images can be prevented and a polarizer having improved visibility can be obtained. The reflectivity is determined by a spectrophotometer (ultraviolet-visible-near infrared rays spentrophotometer V-550 available from JASCO Corporation).

The protective film for a light emission side polarizing sheet exhibits a low variation in reflectivity as measured before and after the abrasion test using a steel wool pad, that is, usually exhibits a reflectivity variation of not larger than 10%, preferably not larger than 8%. When the reflectivity variation is Larger than 10%, images on a display are occasionally blurred to some extent and the glare of light is liable to occur.

The abrasion test using a steel wool pad for the determination of abrasion resistance of the protective film surface of the light emission side polarizing sheet is carried out by reciprocally moving a pad of steel wool #0000 with an imposed load of 0.025 MPa, ten times on the measurement surface of protective film, and measuring the reflectivity of the protective film. The measurement is carried out on five points on the surface of the protective film and an average reflectivity value is calculated from the five measurement values. The variation (ΔR) in reflectivity is calculated from the reflectivities Rb and Ra as measured, respectively, before and after the abrasion test using a steel wool pad, according to the following equation (i).

ΔR=[(Rb−Ra)/Rb]×100(%) Equation (i)

In the liquid crystal device unit according to the present invention, a multilayered body consisting of the total biaxial optical anisotropic substance sheet or sheets and the liquid crystal cell satisfies the following formula:

|R₄₀−R₀|≦35 nm

where R₀ is a retardation as measured without imposition of voltage when light having a wavelength of 550 nm impinges vertically, and R₄₀ is a retardation as measured without imposition of voltage when light having a wavelength of 550 nm impinges at an inclination angle of 40 degrees from the normal to the direction of the principal axis. The above-mentioned multilayered body preferably satisfies the following formula: |R₄₀−R₀=125 nm, more preferably, |R₄₀−R₀|≦15 nm. If the value of R₄₀−R⁰| exceeds 35 nm, the liquid crystal display unit gives images which are poor in quality at black display when viewed at inclined viewing angles, and the contrast of images is lowered.

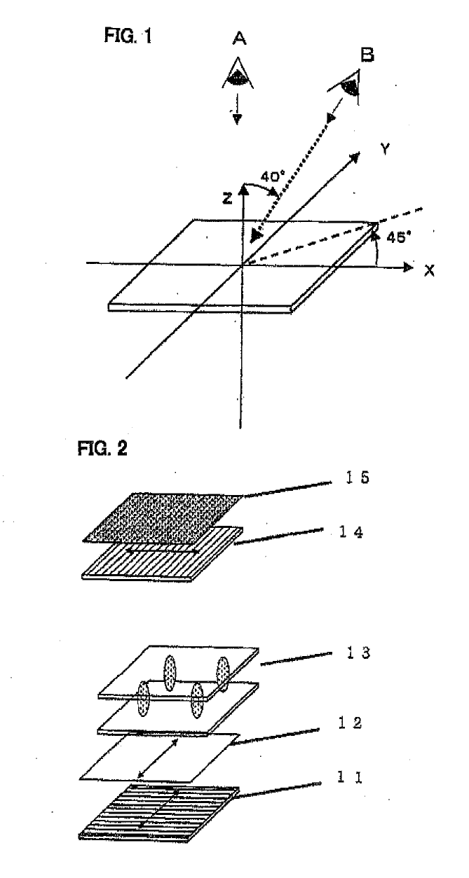

The retardation R⁰ is a retardation as observed when light having a wavelength of 550 nm impinges from A along the normal line to the principal plane, as illustrated in FIG. 1. R₄₀ is a retardation as observed when light having a wavelength of 550 nm impinges from B at an inclination angle (polar angle) of 40 degrees from the normal line to the principal plane, and impinges in a direction at an inclination angle of 45° on the principal plane from the in-plane slow axis X of the optically anisotropic body to the fast axis Y thereof on the principal plane, as illustrated in FIG. 1. Retardation is measured when light with a wavelength of 550 ran is incident from A and B, as illustrated in FIG. 1, using a fast spectroscopic ellipsometer (“M-2000U” available from S. A. Woolam Con).

In the liquid crystal display according to the present invention, it is preferable that the light transmission axis of the light emission side polarizer and/or the light transmission axis of the light incident side polarizer, and the slow axis of the multilayered optical body (A) consisting of the total biaxial optical anisotropic substance sheet or sheets and the liquid crystal cell are approximately parallel or approximately perpendicular to each other as measured without imposition of voltage. By the term “approximately parallel” as used herein we mean that each light transmission axis and the slow axis cross at an intersecting angle of 0 to 3 degrees, preferably 0 to 1 degree, as expressed by the angles ranging 0 to 90 degrees. By the term “approximately perpendicular” as used herein we mean that each light transmission axis and the slow axis cross at an intersecting angle of 87 to 90 degrees, preferably 89 to 90 degree, as expressed by the angles ranging 0 to 90 degrees. The multilayered optical body (A) consisting of the total biaxial optical anisotropic substance sheet or sheets and the liquid crystal cell as used herein as measured without imposition of voltage is the same as that used for the determination of the above-mentioned R₀ and R₄₀. If the light transmission axis of the light emission side polarizer and/or the light transmission axis of the light incident side polarizer, and the slow axis of the multilayered optical body (A) cross at an intersecting angle of larger than 3 degrees and smaller than 87 degrees, light leaks and qualified images become difficult to obtain at black display. The direction of the slow axis of the multilayered optical body (A) consisting of the total biaxial optical anisotropic substance sheet or sheets and the liquid crystal cell can be determined at the measurement of R₀.

In the liquid crystal display unit of the present invention, the multilayer arrangement is not particularly limited provided that at least one biaxial optical anisotropic substance sheet and a liquid crystal call are arranged between a light emission side polarizer and a light incident side polarizer. For example, as illustrated in FIG. 2, a light incident side polarizer 11, a biaxial optical anisotropic substance sheet 12, a liquid crystal cell 13, a light emission side polarizer 14 and a low refractive index layer 15 are superposed in this order. The arrows in the light emission side polarizer and the light incident side polarizer indicate the direction of light transmission axes. The axis in the biaxial optical anisotropic substance sheet indicates the direction of in-plane slow axis. The light transmission axis of the light incident side polarizer and the in-plane slow axis of the light incident side polarizer are approximately parallel.

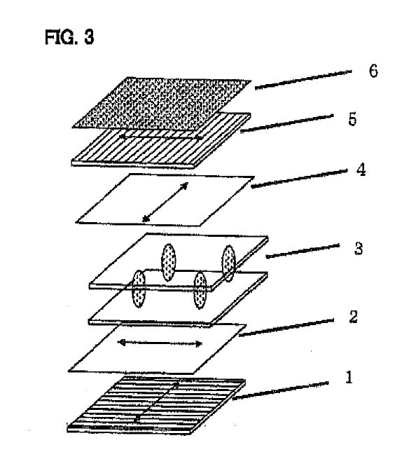

In the case when two biaxial optical anisotropic substance sheets and a liquid crystal cell are used, any of an arrangement of biaxial optical anisoctropic substance sheet-liquid crystal cell-biaxial optical anisotropic substance sheet; an arrangement of biaxial optical anisotropic substance sheet-biaxial optical anisotropic substance sheet-liquid crystal cell; and an arrangement of liquid crystal cell-biaxial optical anisotropic substance sheet-biaxial optical anisotropic substance sheet, can be taken (these arrangements refer to the arrangement from the light incident side polarizer to the light emission side polarizer). One specific example is shown in FIG. 3, wherein a light incident side polarizer 1, a biaxial optical anisotropic substance sheet 2, a liquid crystal cell 3, a biaxial optical anisotropic substance sheet 4, a light emission side polarizer 5 and a low refractive index layer 6 are superposed in this order, The in-plane slow axis of the biaxial optical anisotropic substance sheet 4 is approximately parallel to the light transmission axis of the light incident side polarizer. The in-plane slow axis of the biaxial optical anisotropic substance sheet 2 is approximately parallel to the light transmission axis of the light emission side polarizer.

The liquid crystal display according to the present invention may have provided therein additional films or layers such as a prism array sheet, a lens array sheet, a light diffuser plate, and a luminance-enhancing film. These additional films or layers can be arranged at an appropriate location as a single layer or two or more layers. A back-light such as, for example, cold cathode-ray tube, mercury flat lamp, light emitting diode and electroluminescence can be used in the liquid crystal display unit of the present invention

### EXAMPLES

The invention will now be described specifically by the following examples that by no means limit the scope of the present invention.

In the examples, parts are by weight unless otherwise specified.

The physical properties were evaluated by the following methods in the examples.

### (1) Thickness

An optical multilayer body is embedded in an epoxy resin, and a block of the epoxy resin is sliced into thin films each having a thickness of 0.05 μm by using a microtome (“RUB-2100” available from Yamato Kohki Industrial Co., Ltd.). The measurement of thickness is carried out by observing the cross-section of thin films. With regard to a multilayer, the thickness of each layer is measured.

### (2) Principal Refractive Index

Using an automatic refractive index measuring instrument (“KOBRA-21” available from Oji Scientific Instruments), the direction of in-plane slow axis of an optical anisotropic substance is determined at a wavelength of 550 nm. A refractive index nX in the direction of the in-plane slow axis, a refractive index ny in the direction perpendicular to the in-plane slow axis, and a refractive index n_{z} in the direction of thickness are measured at a temperature of 20° C.±2° C. and a relative humidity of 60%±5%.

### (3) Retardation of Optical Multilayer Body (A)

Using a fast spectroscopic ellipsometer (“M-2000U” available from J. A. Woolam Co.), retardations R₀ and R₄₀ are measured at a temperature of 20° C.±2° C. and a relative humidity of 60%±5%.

### (4) Viewing Angle Characteristics

Viewing angle characteristics of liquid crystal are evaluated by the naked eye observation when the display is viewed at a right angle at a black display, and when the display is viewed at a polar angle of not larger than 80 degrees.

The evaluation results are expressed by the following two ratings.

A: Good and uniform

B: Poor

### (5) Reflectivity

Spectral reflectance is measured at an incident angle of 5 degrees by a spectrophotometer (ultraviolet-visible-near infrared rays spectrophotometer V-570 available from JASCO Corporation). The reflectivity at a wavelength of 550 nm is determined at a temperature of 20° C.: 2° C. and a relative humidity of 60% t 5%.

### (6) Refractive Index of Low Refractive Index Layer and Refractive Index of Hard Coat Layer

Using a fast spectroscopic ellipsometer (“M-2000U” available from J. A. Woolam Co.), spectrophometric measurement is carried out at incident angles of 55, 60 and 65 degrees, and at a temperature of 20° C.±2° C. and a relative humidity of 60%±5%. The refractive indexes are calculated from the photometric curve in a wavelength region of from 400 to 1000 nm.

### (7) Abrasion Resistance

A pad of steel wool #000 with an imposed load of 0.025 MPa is reciprocally moved ten times on a measurement surface. The appearance of tested surface is observed by the naked eyes, and evaluated by the following two ratings.

A: No mar is observed.

B; Surface is marred.

### (8) Visibility

The display panel surface at a black display is observed by the naked eyes, and the visibility characteristics are evaluated by the following three ratings.

A: No glare nor mirroring is observed.

AB: Glare and/or mirroring is slightly observed.

B: Glare and/or mirroring is observed to a considerable extent.

### (9) Wide Band Characteristics

A liquid crystal display panel is disposed under an environmental brightness of 100 lux, and a reflected color is observed by the naked eyes. The Wide band characteristics are expressed by the following two ratings.

A: Reflected color is black.

B: Reflected color is blue.

### (10) Contrast

A liquid crystal display panel is disposed under an environmental brightness of 100 lux, and luminance was measured at an angle of 5° from the normal by using a color luminance tester “BM-7” available from Topcon Co. The measurement is conducted at a black state and a white state, and the contrast (CR) is expressed in terms of a ratio of the luminance as measured at a brightness indication to the luminance as measured at a darkness indication. The larger the luminance ratio (CR), the better the visibility.

### (11) Weight Average Molecular Weight

Weight average molecular weight is measured according to GPC (gel permeation chromatography) using HLC8020 available from Tosoh Corporation. Calibration is made using standard polystyrene, and the weight average molecular weight is expressed in terms of that of standard polystyrene.

### Production Example 1

### Preparation of Raw Film

Pellets of a norbornene polymer (trade name “ZEONOR 1420R” available from Zeon Corporation, glass transition temperature: 136° C., saturation water absorption:below 0.01% by weight) were dried in a hot air drier at 110° C. for 4 hours. The pellets were melt-extruded at 260° C. through a single screw extruder equipped with a coathanger T-die with a lip width of 650 mm and having a die lip provided with a leaf disc-shaped polymer filter (filtration precision: 30 μm). The inner surface of the tip of die lip used was chromium-plated and had a surface roughness Ra of 0.04 μm. Thus, a raw film having a thickness of 200 μm, and a width of 600 mm was obtained.

### Production Example 2

### Preparation of Optically Anisotropic Substance Film 1

The raw film obtained in production Example 1 was subjected to concurrent biaxial orientation using a concurrent biaxially stretching machine. The oven temperature for pre-heating the raw film, stretching the raw film and heat-setting the stretched film was 138° C. The stretching conditions were as follows. Feed rate of the raw film: 1 m/min, precision of chucks movement: smaller than 1%, stretch ratio in the longitudinal direction:1.41, and stretch ratio in the transverse direction:1.41. The thus-obtained optically anisotropic substance film 1 had a thickness of 100 μm, and principal indexes nₓ of 1.53068, n_{y} of 1.53018 and n_{z} of 1.52913.

### Production Example 3

### Preparation of Optically Anisotropic Substance Film 2

The procedures described in Production Example 2 were repeated wherein the oven temperature was changed to 134° C. with all other conditions remaining the same. The thus-obtained optically anisotropic substance film 2 had a thickness of 100 μm, and principal indexes nₓ of 1.53108, n_{y} of 1.53038 and n_{z} of 1.52853.

### Production Example 4

### Preparation of Hard Coat Layer-Forming Composition H1

30 parts of hexa-functional urethane acrylate oligomer (“NK Oligo U-6HA” available from Shin-Nakamura Chem. Co.), 40 parts of butyl acrylate, 30 parts of isoboronyl methacrylate (“NK Ester IB” available from Shin-Nakamura Chem. Co.) and 10 parts of 2,2-diphenylethan-1-on were mixed together by a homogenizer. The mixture was mixed with a 40% solution of fine antimony pentoxide particles in methyl isobutyl ketone to prepare a coating solution H1 for forming a hard coat layer. The antimony pentoxide particles had an average article diameter of 20 nm and a pyrochlore structure such that one hydroxyl group is bonded to each antimony atom appearing on the surface of the pyrochlore structure. The hard coat layer-forming coating solution Hi contained the fine antimony pentoxide particles at a concentration of 50% by weight based on the total solid content in the coating solution.

### Production Example 5

### Preparation of Low Refractive Index Layer-Forming Composition L1

To 166.4 parts of tetraethoxysilane, 392.6 parts of methanol, 11.7 parts of heptadecafluorodecyltriethoxysilane CF₃(CF₂)₇CH₂CH₂Si(OC₂H₅)₃, and 29.3 parts of a 0.005N aqueous hydrochloric acid solution ([H₂O]/[OR]=0.5) were added in this order. The mixture was thoroughly mixed together by a disper. The mixed liquid was stirred at 25° C. for 2 hours in a thermostat vessel to give a fluorine/silicone copolymerization-hydrolysis product (B) having a weight average molecular weight of 830 as a matrix-forming material (solid content of the condensed compound:10%).

Then a sol of fine hollow silica particles dispersed in IPA (isopropanol) (solid content: 20% by weight, average primary particle diameter: about 60 nm, shell thickness: about 10 nm, supplied by Catalysts and Chemicals Ind. Co., Ltd.) was added and mixed together with the above-mentioned fluorine/silicone copolymerization-hydrolysis product (B). The ratio of the fine hollow silica particles/the copolymerization-hydrolysis product (B) (as solid content of the condensed compound) was 50/50 by weight. The mixed liquid was diluted with a mixed solvent of IPA/butyl acetate/butyl cellosolve to prepare a solution having a 1% solid content. The composition of the mixed solvent had been previously adjusted so that the resulting 1% solid content solution contained 5% of butyl acetate and 2% of butyl cellosolve, based on the total weight of the solution. Dimethylsiliconediol (n=about 40) was diluted with ethyl acetate to prepare a solution having a 1% solid content. This dimethylsiliconediol solution was added to the above-mentioned 1% solid content solution of the fine hollow silica particles/the copolymerization-hydrolysis product (8) to prepare a low refractive index layer-forming composition L1. The composition L1 contained 2% by weight of dimethylsiliconediol as solid content based on the total solid content of the fine hollow silica particles/the copolymerization-hydrolysis product (B) (solid content as the condensed compound).

### Production Example 6

### Preparation of Low Refractive Index Layer-Forming Composition L2

To 208 parts of tetraethoxysilane, 356 parts of methanol and 36 parts of a 0.005N aqueous hydrochloric acid solution ([H₂O]/[OR]=0.5) were added in this order. The mixture was thoroughly mixed together by a disper. The thus-obtained mixed liquid was stirred at 25° C. for 2 hours in a thermostat vessel to give a silicone hydrolysis product (A) having a weight average molecular weight of 850 as a matrix-forming material (solid content as the condensed compound:10%).

Then a sol of fine hollow silica particles in IPA (isopropanol) (solid content; 20% by weight, average primary particle diameter: about 60 mm, shell thickness: about 10 nm, supplied by Catalysts and Chemicals Ind. Co., Ltd.) was added and mixed together with the above-mentioned silicone hydrolysis product (A). The ratio of the fine hollow silica particles/the copolymerization-hydrolysis product (A) (as solid content of the condensed compound) was 60/40 by weight. The mixed liquid was diluted with a mixed solvent of IPA/butyl acetate/butyl cellosolve to prepare a solution having a 1% solid content.

The composition of the mixed solvent had been previously adjusted so that the resulting 1% solid content solution contained 5% of butyl acetate and 2% of butyl cellosolve, based on the total weight of the solution. Dimethylsiliconediol (n=about 250) was diluted with ethyl acetate to prepare a solution having a 1% solid content. This dimethylsiliconediol solution was added to the above-mentioned 1% solid content solution of the fine hollow silica particles/the copolymerization-hydrolysis product (A) to prepare a low refractive index layer-forming composition L2. The composition L2 contained 2% by weight of dimethylsiliconediol as solid content based on the total solid content of the fine hollow silica particles/the copolymerization-hydrolysis product (A) (as the condensed compound).

### Production Example 7

### Preparation of Low Refractive Index Layer-Forming Composition L3

To 166.4 parts of tetraethoxysilane, 493.1 parts of methanol and 30.1 parts of a 0.005N aqueous hydrochloric acid solution ([H₂O]/[OR]=0.5) were added in this order. The mixed liquid was thoroughly mixed together by a disper. The thus-obtained mixed liquid was stirred at 25° C. for 2 hours in a thermostat vessel to give a silicone hydrolysis product (A) having a weight average molecular weight of 850. Then 30.4 parts of (H₃CO)₃SiCH₂CH₂ (CF₂)₇CH₂CH₂Si (OCH₃)₃ was added as component (C) to the silicone hydrolysis product (A), and the mixed liquid was stirred at 25° C. for 1 hour in a thermostat vessel to give a matrix-forming material containing 10% of the condensed compound as solid content.

Then a sol of fine hollow silica particles dispersed in IPA (isopropanol) (solid content: 20% by weight, average primary particle diameter: about 60 nm, shell thickness: about 10 nm, supplied by Catalysts and Chemicals Ind. Co., Ltd.) was added and mixed together with the above-mentioned silicone hydrolysis product (A). The ratio of the fine hollow silica particles/the matrix-forming material (as solid content of the condensed compound) was 40/60 by weight. The mixed liquid was diluted with a mixed solvent of IPA/butyl acetate/butyl cellosolve to prepare a solution having a 1% solid content. The composition of the mixed solvent had been previously adjusted so that the resulting 1% solid content solution contained 5% of butyl acetate and 2% of butyl cellosolve. Dimethylsiliconediol (n=about 40) was diluted with ethyl acetate to prepare a solution having a 1% solid content. This dimethylsiliconediol solution was added to the above-mentioned 1% solid content solution of the fine hollow silica particles/the matrix-forming material (as solid content of the condensed compound) to prepare a low refractive index layer-forming composition L3. The composition L3 contained 2% by weight of dimethylsiliconediol as solid content based on the total solid content of the fine hollow silica particles/the matrix-forming material.

### Production Example 8

### Preparation of Low Refractive Index Layer-Forming Composition L4

To 208 parts of tetraethoxysilane, 356 parts of methanol, and 36 parts of a 0.005N aqueous hydrochloric acid solution ([H₂O]/[OR]=0.5) were added in this order. The mixture was thoroughly mixed together by a disper. The thus-obtained mixed liquid was stirred at 25° C. for 1 hour in a thermostat vessel to give a silicone hydrolysis product (A) having a weight average molecular weight of 780 as a matrix-forming material.

Then a sol of fine hollow silica particles dispersed in IPA (isopropanol) (solid content; 20% by weights average primary particle diameter: about 60 nm, shell thickness: about 10 nm, supplied by Catalysts and Chemicals Ind. Co., Ltd.) was added and mixed together with the above-mentioned silicone hydrolysis product (A). The ratio of the fine hollow silica particles/the matrix-forming material (as solid content of the condensed compound) was 50/50 by weight. The thus-obtained mixed liquid was stirred at 25° C. for 2 hours in a thermostat vessel to give a re-hydrolysis product having a weight average molecular weight of 980 (solid content of the condensed compound:10%).

To 104 parts of tetraethoxysilane, 439.8 parts of methanol, 36.6 parts of heptadecafluorodecyltriethoxysilane CF₃(CF₂)₇CH₂CH₂Si(OC₂H5)₃, and 19.6 parts of a 0.005N aqueous hydrochloric acid solution ([H₂O]/[OR]=0.5) were added in this order. The mixture was thoroughly mixed together by a disper. The mixed liquid was stirred at 25° C. for 2 hours in a thermostat vessel to give a fluorine/silicone copolymerization-hydrolysis product (B) having a weight average molecular weight of 850 (solid content of the condensed compound:10%).

The re-hydrolysis product containing the fine hollow silica particles was mixed together with the copolymerizetion-hydrolysis product (3) so that the ratio of the re-hydrolysis product/the copolymerization-hydrolysis product (B) was 80/20 by weight as solid content. The mixed liquid was diluted with a mixed solvent of IPA/butyl acetate/butyl cellosolve to prepare a low refractive index layer-forming composition L4 having a solid content of 1%. The composition of the mixed solvent had been previously adjusted so that the resulting composition L4 contained 5% of butyl acetate and 2% of butyl cellosolve.

### Production Example 9

### Preparation of Low Refractive Index Layer-Forming Composition L5

To 166.4 parts of tetraethoxysilane, 493.1 parts of methanol, and 30.1 parts of a 0.005N aqueous hydrochloric acid solution ([H₂O]/[OR]=0.5) were added in this order. The mixture was thoroughly mixed together by a disper. The thus-obtained mixed liquid was stirred at 25° C. for 2 hours in a thermostat vessel to give a silicone hydrolysis product (A) having a weight average molecular weight of 850.

Then 30.4 parts of (H₃CO)₃SiCH₂CH₂(CF₂)₇CH₂CH₂Si(OCH₃)3 was added as component (C) to the silicone hydrolysis product (A), and the mixed liquid was stirred at 25° C. for 1 hour in a thermostat vessel to give a matrix-forming material containing 10% of the condensed compound as solid content.

Tetramethoxysilane, methanol, water and 28% aqueous ammonia were mixed together at a proportion of 470:812:248:6 by mass, respectively, to prepare a mixed solution. The mixed solution was stirred for 1 minute. Then 20 parts by weight of hexamethyldisilazane was added to 100 parts by weight of the mixed solution, and the thus-obtained mixture was diluted with the same amount of IPA to stop the polymerization before gelling of the mixture. Thus stabilized organosilica-sol having dispersed therein fine porous silica particles with an average particle diameter of 50 nm was obtained.

Then a sol of fine hollow silica particles dispersed in IPA (isopropanol) (solid content: 20% by weight, average primary particle diameter: about 60 nm r, shell thickness: about 10 nm, supplied by Catalysts and Chemicals Ind. Co., Ltd.) was added and mixed together with the above-mentioned silicone hydrolysis product (A). The ratio of the fine hollow silica particles/porous silica particles/the matrix-forming material (as solid content of the condensed compound) was 30/10/60 by weight. The mixed liquid was diluted with a mixed solvent of IPA/butyl acetate/butyl cellosolve to prepare a solution having a 1% solid content. The composition of the mixed solvent had been previously adjusted so that the resulting 1% solid content solution contained 5% of butyl acetate and 2% of butyl cellosolve, Dimethylsiliconediol (n=about 250) was diluted with ethyl acetate to prepare a solution having a 1% solid content. This dimethylsiliconediol solution was added to the above-mentioned 1% solid content solution of the fine hollow silica particles/porous silica particles/the matrix-forming material (as solid content of the condensed compound) to prepare a low refractive index layer-forming composition L5. The composition LS contained 2% by weight of dimethylsiliconediol as solid content based on the total solid content of the fine hollow silica particles/the matrix-forming material (as solid content of the condensed Compound).

### Production Example 10

### Preparation of Low Refractive Index Layer-Forming Composition L6

To 156 parts of tetraethoxysilane, 402.7 parts of methanol, 13.7 parts of heptadecafluorodecyltriethoxysilane CF₃ (CF₂)₇CH₂CH₂Si (OC₂H₅)₃, and 27.6 parts of a 0.005N aqueous hydrochloric acid solution ([H₂O]/[OR]=0.5) were added in this order. The mixture was thoroughly mixed together by a disper. The mixed liquid was stirred at 25° C. for 2 hours in a thermostat vessel to give a fluorine/silicone copolymerization-hydrolysis product (B) having a weight average molecular weight of 830 as a matrix-forming material (solid content of the condensed compound:10%).

To 208 parts of tetraethoxysilane, 356 parts of methanol, 126 parts of water, and 18 parts of a 0.01N aqueous hydrochloric acid solution (1H₂O)/[OR]=2.0) were added in this order. The mixture was thoroughly mixed together by a disper. The mixed liquid was stirred at 60° C. for 20 hours in a thermostat vessel to give a silicone-complete hydrolysis product having a weight average molecular weight of 8,000 (solid content of the condensed compound:10%).

Then a sol of fine hollow silica particles dispersed in IPA (isopropanol) (solid content: 20% by weight, average primary particle diameter: about 60 nm, shell thickness: about 10 nm, supplied by Catalysts and Chemicals Ind. Co., Ltd.) was added and mixed together with the above-mentioned fluorine/silicone copolymerization-hydrolysis product (B) and the silicone-complete hydrolysis product. The ratio of the fine hollow silica particles/the copolymerization-hydrolysis product (B)/the silicone-complete hydrolysis product (as solid content of the condensed compound) was 50/40/10 by weight. The mixed liquid was diluted with a mixed solvent of IPA/butyl acetate/butyl cellosolve to prepare a solution having a 1% solid content. The composition of the mixed solvent had been previously adjusted so that the resulting 1% solid content solution contained 5% of butyl acetate and 2% of butyl cellosolve. Dimethylsiliconediol (n=about 40) was diluted with ethyl acetate to prepare a solution having a 1% solid content. This dimethylsiliconediol solution was added to the above-mentioned 1% solid content solution of the fine hollow silica particles/the copolymerization-hydrolysis product (B)/the silicone-complete hydrolysis product to prepare a low refractive index layer-forming composition L6. The composition L6 contained 4% by weight of dimethylsiliconediol as solid content based on the total solid content of the fine hollow silica particles/the copolymerization-hydrolysis product (B)/the silicone-complete hydrolysis product.

### Production Example 11

### Preparation of Low Refractive Index Layer-Forming Composition L7

To 166.4 parts of tetraethoxysilane, 493.1 parts of methanol, and 30.1 parts of a 0.005N aqueous hydrochloric acid solution (H₂O/[OR]=0.5) were added in this order. The mixture was thoroughly mixed together by a disper. The mixed liquid was stirred at 25° C. for 1 hour in a thermostat vessel to give a silicone hydrolysis product (A) having a weight average molecular weight of 800. Then 30.4 parts of (H₃CO)₃SiCH₂CH₂(CF₂)₇C₂CH₂Si(OCH₃)₃ was added as component (C) to the silicone hydrolysis product (A), and the mixed liquid was stirred at 25° C. for 1 hour in a thermostat vessel to give a matrix-forming material having a weight average molecular weight of 950 (solid content of the condensed compound:10%).

Then a sol of fine hollow silica particles dispersed in IPA (isopropanol) (solid content 20% by weight, average primary particle diameter; about 60 nm, shell thickness: about 10 nm, supplied by Catalysts and Chemicals Ind. Co., Ltd.) was added and mixed together with the above-mentioned matrix-forming material. The ratio of the fine hollow silica particles/the copolymerization-hydrolysis product (B) (as solid content of the condensed compound) was 30/70 by weight. The mixed liquid was diluted with a mixed solvent of IPA/butyl acetate/butyl cellosolve to prepare a solution having a 1% solid content. The composition of the mixed solvent had been previously adjusted so that the resulting 1% solid content solution contained 5% of butyl acetate and 2% of butyl cellosolve. Dimethylsiliconediol (n=about 40) was diluted with ethyl acetate to prepare a solution having a 1% solid content. This dimethylsiliconediol solution was added to the above-mentioned 1% solid content solution of the fine hollow silica particles/the copolymerization-hydrolysis product (B) to prepare a low refractive index layer-forming composition L7. The composition L7 contained 2% by weight of dimethylsiliconediol as solid content based on the total solid content of the fine hollow silica particles/the matrix-forming material (as solid content of the condensed compound).

### Production Example 12

### Preparation of Polarizing Film

A PVA film (Vinylon #7500 available from Kurary Co., Ltd.) with a thickness of 75 μm was seized firmly by a chuck, and immersed in an aqueous solution containing 0.2 g/l of iodine and 60 g/l of potassium iodide at 30° C. for 240 seconds. Then the film was uniaxially stretched at a draw ratio of 6.0 in the longitudinal direction in an aqueous solution containing 70 g/l of boric acid and 30 g/l of potassium iodide. Thus the film was treated with boric acid for 5 minutes. Finally the film was dried at room temperature for 24 hours to give a polarizing film having an average thickness of 30 μn and a polarization degree of 99.993%.

### Production Example 13

### Preparation of Polarizing Sheet P

One surface of triacetyl cellulose film (KC8UX2M, available from Konica-Minolta Corp,) was coated with a 1.5N potassium hydroxide solution in isopropyl alcohol in an amount of 25 ml/m², and then the liquid coating was dried at 25° C. for 5 seconds. The film was washed with stream of water for 10 seconds and then air was blown at 25° C. against the washed film to dry the film surface. Thus one surface of the triacetyl cellulose film was saponified. The saponified surface of triacetyl cellulose film was adhered to the polarizing film prepared in Production Example 12 by using polyvinyl alcohol adhesive by a roll-to-roll method to give a polarizing sheet P having the triacetyl cellulose film on the light incident side.

### Production Example 14

### Preparation of Polarizing Sheet with Low Refractive Index (TAC Substrate)

One surface of triacetyl cellulose film (KC8UX2M, available from Konica-Minolta Corp.) was coated with a 1.5N potassium hydroxide solution in isopropyl alcohol in an amount of 25 ml/m², and then the liquid coating was dried at 25° C. for 5 seconds. The film was washed with stream of water for 10 seconds and then air was blown at 25° C. against the washed film to dry the film surface. Thus one surface of the triacetyl cellulose film was saponified.

The other surface of the triacetyl cellulose film was subjected to corona discharge treatment using high frequency source (AGI-024, available from Kasuga Electric. Co.; output 0.8 KW) to give a substrate film having a modified surface with a surface tension of 0.055 N/m.

The modified surface (corona discharge-treated surface) of the substrate film was coated with the hard coat layer-forming composition H1, prepared in Production Example 4, by using a die coater. The coating was dried at 80° C. for 5 minutes in a drying oven, and then irradiated with ultraviolet rays at an integrated light quantity of 300 mJ/cm² whereby the hard coat layer-forming composition was cured to form a hard coat layer-laminated film 1A. The hard coat layer had a thickness of 5 μm, a refractive index of 1.62, and a pencil hardness of 2H.

One surface (i.e., hard coat layer-formed surface) of the hard coat layer-laminated film 1A was coated with the low refractive index layer-forming composition L1, prepared in Production Example 5, by using a wire-bar coater. The coating was left to stand for 1 hour to be thereby dried. The dried film was heat-treated at 120° C. for 10 minutes in an oxygen atmosphere, to give a substrate film (TAC substrate film) with a low refractive index layer. The low refractive index layer had a thickness of 100 nm.

The polarizing film produced in Product Example 12 was adhered on the saponified surface of the substrate film with a low refractive index layer through a polyvinyl alcohol adhesive by a roll-to-roll method. Thus a polarizing sheet 2A with a low refractive index layer (TAC substrate) was obtained.

### Production Example 15

### Preparation of Polarizing Sheet with Low Refractive Index (COP Substrate)

Both surfaces of the raw film prepared in Production Example 1 were subjected to corona discharge treatment using high frequency source (AGI-024, available from Kasuga Electric. Co.; output 0.8 KW) to give a substrate film having modified surfaces with a surface tension of 0.072 N/m.

One modified surface (corona discharge-treated surface) of the raw film was coated with the hard coat layer-forming composition H1, prepared in Production Example 4, by using a die coater. The coating was dried at 80° C. for 5 minutes in a drying oven, and then irradiated with ultraviolet rays at an integrated light quantity of 300 mJ/cm² whereby the hard coat layer-forming composition was cured to form a hard coat layer-laminated film 1B. The hard coat layer had a thickness of 5 μm, a refractive index of 1.62, and a pencil hardness of H.

The hard coat layer-formed surface of the hard coat layer-laminated film is was coated with the low refractive index layer-forming composition L3, prepared in Production Example 7, by using a wire-bar coater. The coating was left to stand for 1 hour to be thereby dried. The dried film was heat-treated at 120° C. for 10 minutes in an oxygen atmosphere, to gave a substrate film (COP substrate film) with a low refractive index layer. The low refractive index layer had a thickness of 100 nm.

The polarizing film produced in Product Example 12 was adhered on the other surface (opposite to the low refractive index layer-formed surface) of the substrate film through a polyvinyl alcohol adhesive by a roll-to-roll method. Thus a polarizing sheet 2C with a low refractive layer (COP substrate) was obtained.

### Example 1

### Production of Liquid Crystal Display Unit 1

Optically anisotropic substance film 1 prepared in Production Example 2 (hereinafter referred to “optically anisotropic film 1a”), a VA mode liquid crystal cell (thickness: 2.74 μm, dielectric anisotropy; positive, birefringence difference Δn=0.09884 at wavelength of 550, pretilt angle: 90 degree) and another optically anisotropic substance film 1 prepared in Production Example 2 (hereinafter referred to “optically anisotropic film 1b”) were laminated in this order in a manner such that the slow axis of optically anisotropic film 1a was perpendicular to the slow axis of optically anisotropic film 1b, to give an optical multilayer body 1.

In the optical multilayer body 1, retardation R₀ when light having wavelength of 550 nm was vertically incident was 2 nm, R₄₀ when the light was incident at a polar angle of 40 degrees inclined from the normal was 13 nm, and thus |R₄₀−R₀| was 11 nm.

Polarizing sheet P prepared in Production Example 13 and the optical multilayer body 1 were laminated together in a manner such that the absorption axis of the polarizing sheet P was perpendicular to the slow axis of the optically anisotropic film 1a, and the surface of polarizing sheet P opposite to the protective film side is placed in contact with the optically anisotropic film 1a.

Polarizing sheet 2A with a low refractive index layer (TAC substrate) prepared in Production Example 14 and the optical multilayer body 1 were laminated together in a manner such that the slow axis of optically anisotropic film 1b was perpendicular to the absorption axis of the polarizing sheet 2A with a low refractive index layer (TAC substrate), and the optically anisotropic film 1b was placed in contact with the low refractive index layer-non-adhered surface of the polarizing sheet 2A with a low refractive index layer (TAC substrate), to give a liquid crystal display unit 1.

Display characteristics of the liquid crystal display unit 1 were evaluated by the naked eyes. Images on the display surface were good and uniform when viewed in the direction perpendicular to the surface and viewed obliquely at a polar angle within 80 degree. The evaluation results are shown in Table 1.

### Example 2

### Production of Liquid Crystal Display Unit 2

By the same procedures as in Production Example 14, polarizing sheet 2B with a low refractive index layer (TAC substrate) was prepared wherein the low refractive index layer-forming composition L2, prepared in Production Example 6, was used instead of the low refractive index layer-forming composition L1 with all other conditions remaining the same.

By the same procedures as in Example 1, a liquid crystal display unit 2 was made wherein the polarizing sheet 2B with a low refractive index layer (TAC substrate) was used instead of the polarizing sheet 2A with a low refractive index layer (TAC substrate) with all other conditions remaining the same.

The evaluation results of the liquid crystal display unit 2 are shown in Table 1.

### Example 3

### Production of Liquid Crystal Display Unit 3

By the same procedures as in Example 1, a liquid crystal display unit 3 was made wherein the polarizing sheet 2C with a low refractive index layer (COP substrate), prepared in Production Example 15, was used instead of the polarizing sheet 2A with a low refractive index layer (TAO substrate) with all other conditions remaining the same.

The evaluation results of the liquid crystal display unit 3 are shown in Table 1.

### Example 4

### Production of Liquid Crystal Display Unit 4

By the same procedures as in Production Example 14, polarizing sheet 2D with a low refractive index layer (TAC substrate) was prepared wherein the low refractive index layer-forming composition L4 prepared in Production Example 8 was used instead of the low refractive index layer-forming composition L1 with all other conditions remaining the same.

By the same procedures as in Example 1, a liquid crystal display unit 4 was made wherein the polarizing sheet 2D with a low refractive index layer (TAC substrate) was used instead of the polarizing sheet 2A with a low refractive index layer (TAC substrate) with all other conditions remaining the same, The evaluation results of the liquid crystal display unit 4 are shown in Table 1.

### Example 5

### Production of Liquid Crystal Display Unit 5

By the same procedures as in Production Example 14, polarizing sheet 2E with a low refractive index layer (TAC substrate) was prepared wherein the low refractive index layer-forming composition L5 prepared in Production Example 9 was used instead of the low refractive index layer-forming composition L1 with all other conditions remaining the same, By the same procedures as in Example 1, a liquid crystal display unit 5 was made wherein the polarizing sheet 2E with a low refractive index layer (TAC substrate) was used instead of the polarizing sheet 2A with a low refractive index layer (TAC substrate) with all other conditions remaining the same.

The evaluation results of the liquid crystal display unit 5 are shown in Table 1.

### Example 6

### Production of Liquid Crystal Display Unit 6

By the same procedures as in Production Example 14, polarizing sheet 2F with a low refractive index layer (TAC substrate) was prepared wherein the low refractive index layer-forming composition L6 prepared in Production Example to was used instead of the low refractive index layer-forming composition L1 with all other conditions remaining the same.

By the same procedures as in Example 1r a liquid crystal display unit 6 was made wherein the polarizing sheet 2F with a low retractive index layer (TAC substrate) was used instead of the polarizing sheet 2A with a low refractive index layer (TAC substrate) with all other conditions remaining the same.

The evaluation results of the liquid crystal display unit 6 are shown in Table 1.

### Example 7

### Production of Liquid Crystal Display Unit 7

By the same procedures as in Example 1, an optical multilayer body 2 was made wherein triacetyl cellulose film (nx=1.48020, ny=1.48014 and nz=1.47967) having a thickness of 80 μm was used instead of the optically anisotropic film 1b, and the optically anisotropic substance film 2, prepared in Production Example 3, was used instead of the optically anisotropic film 1a with all other conditions remaining the same.

In the optical multilayer body 2, retardation R⁰ when light having wavelength of 550 nm was vertically incident was 65 nm, R₄₀ when the light was incident at a polar angle of 40 degrees inclined from the normal was 49 nm, and thus |R₄₀−R₀| was 16 nm.

Polarizing sheet F prepared in Production Example 13 and the optical multilayer body 2 were laminated together in a manner such that the absorption axis of the polarizing sheet P was perpendicular to the slow axis of the optical multilayer body 2, and the protective film-non-adhered surface of the polarizing sheet P was placed in contact with the optical multilayer body 2.

Polarizing sheet 2A with a low refractive index layer (TAC substrate) prepared in Production Example 14 and the optical multilayer body 2 were laminated together in a manner such that the slow axis of the triacetyl cellulose film was perpendicular to the absorption axis of the polarizing sheet 2A with a low refractive index layer (TAC substrate), and the triacetyl cellulose film was placed in contact with the low refractive index layer-non-adhered surface of the polarizing sheet 2A with a low refractive index layer (TAC substrate), to give a liquid crystal display unit 7.

The evaluation results of the liquid crystal display unit 7 are shown in Table 1.

### Example 8

### Production of Liquid Crystal Display Unit 8

The optical multilayer body 2 made in Example 7 was laminated together with the polarizing sheet Polarizing sheet P, prepared in Production Example 13, in a manner such that the absorption axis of the polarizing sheet P was perpendicular to the slow axis of the optical multilayer body 2, and the protective film-non-adhered surface of the polarizing sheet P was placed in contact with the optical multilayer body 2.

Polarizing sheet 2C with a low refractive index layer (COP substrate) prepared in Production Example 15 and the optical multilayer body 2 were laminated together in a manner such that the slow axis of the triacetyl cellulose film was perpendicular to the absorption axis of the polarizing sheet 2C with a low refractive index layer (COP substrate), and the triacetyl cellulose film was placed in contact with the low refractive index layer-non-adhered surface of the polarizing sheet 2c with a low refractive index layer (COP substrate), to give a liquid crystal display unit B.

The evaluation results of the liquid crystal display unit 8 are shown in Table 1.

### Comparative Example 1

### Production of Liquid Crystal Display Unit 9

By the same procedures as in Example 1, an optical multilayer body 3 was made wherein triacetyl cellulose film (nx=1.48020, ny=1.48014 and nz=1.47967) having a thickness of 80 μm was used instead of each of the optically anisotropic films 1a and 1b with all other conditions remaining the same.

In the optical multilayer body 3, retardation R₀ when light having wavelength of 550 nm was vertically incident was 3 nm, R₄₀ when the light was incident at a polar angle of 40 degrees inclined from the normal was 41 nm, and thus |R₄₀−R₀| was 38 nm.

Polarizing sheet P prepared in Production Example 13 and the optical multilayer body 3 were laminated together in a manner such that the absorption axis of the polarizing sheet P was perpendicular to the slow axis of the triacetyl cellulose film of the optical multilayer body 3, and the protective film-non-adhered surface of the polarizing sheet P was placed in contact with the triacetyl cellulose film of the optical multilayer body 3.

Polarizing sheet 2A with a low refractive index layer (TAC substrate) prepared in Production Example 14 and the optical multilayer body 3 were laminated together in a manner such that the slow axis of the triacetyl cellulose film was perpendicular to the absorption axis of the polarizing sheet 2A with a low refractive index layer (TAC substrate), and the triacetyl cellulose film was placed in contact with the low refractive index layer-non-adhered surface of the polarizing sheet 2A with a low refractive index layer (TAC substrate), to give a liquid crystal display unit 9.

The evaluation results of the liquid crystal display unit 9 are shown in Table 1.

### Comparative Example 2

### Production of Liquid Crystal Display Unit 10

By the same procedures as in Example 1, a liquid crystal display unit 10 was made wherein the hard coat layer-laminated film 1A, prepared in Production Example 1, was used instead of the polarizing sheet 2A with a low refractive index layer (TAC substrate) with all other conditions remaining the same.

The evaluation results of the liquid crystal display unit 10 are shown in Table 1.

### Comparative Example 3

### Production of Liquid Crystal Display Unit 11

By the same procedures as in Production Example 14, polarizing sheet 2G with a low refractive index layer (TAC substrate) was prepared wherein the low refractive index layer-forming composition L7 prepared in Production Example 11 was used instead of the low refractive index layer-forming composition L1 with all other conditions remaining the same.

By the same procedures as in Example 1, a liquid crystal display unit 11 was made wherein the polarizing sheet 2G with a low refractive index layer (TAC substrate) was used instead of the polarizing sheet 2A with a low refractive index layer (TAC substrate) with all other conditions remaining the same.

The evaluation results of the liquid crystal display unit 11 are shown in Table 1.

As seen from Table 1, in the liquid crystal display units in Examples 1 to 8, visibility is good, i.e., glare and mirroring do not occur, reflectivity is small, color of reflection is black, and abrasion resistance is large. In contrast, in the liquid crystal display units in Comparative Examples 1 to 3, visibility is poor, i.e., glare and mirroring occur, reflectivity is large, color of reflection is blue, and abrasion resistance is poor.

TABLE 1

| | Examples | | | | | | | | Comparative Examples | | |
|---|---|---|---|---|---|---|---|---|---|---|---|
| | 1 | 2 | 3 | 4 | 5 | 6 | 7 | 8 | 1 | 2 | 3 |
| Optically | BS | BS | BS | BS | BS | BS | BS + | BS + | TAC | BS | BS |
| anisotropic | 2 sheets | 2 sheets | 2 sheets | 2 sheets | 2 sheets | 2 sheets | TAC | TAC | 2 sheets | 2 sheets | 2 sheets |
| body | | | | | | | | | | | |
| \|R₄₀ − R₀\| | 11 | 11 | 11 | 11 | 11 | 11 | 16 | 16 | 38 | 11 | 11 |
| Hard coat layer- | H1 | H1 | H1 | H1 | H1 | H1 | H1 | H1 | H1 | H1 | H1 |
| forming | | | | | | | | | | | |
| composition | | | | | | | | | | | |
| Refractive index | 1.62 | 1.62 | 1.62 | 1.62 | 1.62 | 1.62 | 1.62 | 1.62 | 1.62 | 1.62 | 1.62 |
| of hard coat layer | | | | | | | | | | | |
| Low RI layer- | L1 | L2 | L3 | L4 | L5 | L6 | L1 | L5 | L1 | — | L7 |
| forming | | | | | | | | | | | |
| composition | | | | | | | | | | | |
| Refractive index | 1.35 | 1.34 | 1.37 | 1.36 | 1.36 | 1.33 | 1.35 | 1.36 | 1.33 | — | 1.40 |
| of low RI layer | | | | | | | | | | | |
| Viewing angle | A | A | A | A | A | A | A | A | B | A | A |
| characteristics | | | | | | | | | | | |
| Contrast | 370 | 380 | 320 | 350 | 350 | 400 | 280 | 300 | 200 | 150 | 250 |
| Reflectivity | 0.6 | 0.5 | 0.6 | 0.6 | 0.6 | 0.4 | 0.6 | 0.6 | 0.6 | 5 | 1.3 |
| Wide band | A | A | A | A | A | A | A | A | A | — | B |
| characteristics | | | | | | | | | | | |
| Visibility | A | A | A | A | A | A | A | A | A | B | AB |
| Abrasion | A | A | A | A | A | A | A | A | A | B | A |
| resistance | | | | | | | | | | | |
| Laminated film | 1A(14) | 1A(14) | 1B(15) | 1A(14) | 1A(14) | 1A(14) | 1A(14) | 1B(15) | 1A(14) | 1A(14) | 1A(14) |
| (substrate + HC) | | | | | | | | | | | |
| Polarizer with | 2A(14) | 2B | 2C(15) | 2D | 2E | 2F | 2A(14) | 2C(15) | 2A(14) | — | 2F |
| low RI layer *1 | | | | | | | | | | | |
| Low RI layer- | L1(5) | L2(6) | L3(7) | L4(8) | L5(9) | L6(10) | L1(5) | L3(7) | L1(5) | — | L7(11) |
| forming | | | | | | | | | | | |
| composition | | | | | | | | | | | |
| Hard coat layer- | H1(4) | H1(4) | H1(4) | H1(4) | H1(4) | H1(4) | H1(4) | H1(4) | H1(4) | H1(4) | H1(4) |
| forming | | | | | | | | | | | |
| composition | | | | | | | | | | | |
| Film (TAC or | TAC | TAC | COP(1) | TAC | TAC | TAC | TAC | COP(1) | TAC | TAC | TAC |
| ZNR) | | | | | | | | | | | |
| PVA | PVA(12) | PVA(12) | PVA(12) | PVA(12) | PVA(12) | PVA(12) | PVA(12) | PVA(12) | PVA(12) | PVA(12) | PVA(12) |
| Optically | 1b | 1b | 1b | 1b | 1b | 1b | TAC | TAC | TAC | 1b | 1b |
| anisotropic | | | | | | | | | | | |
| body *2 | | | | | | | | | | | |
| Liquid crystal cell | VA | VA | VA | VA | VA | VA | VA | VA | VA | VA | VA |
| Optically | 1a | 1a | 1a | 1a | 1a | 1a | 2 | 2 | TAC | 1a | 1a |
| anisotropic | | | | | | | | | | | |
| body *2 | | | | | | | | | | | |
| PVA, TAC | P*(13) | P*(13) | P*(13) | P*(13) | P*(13) | P*(13) | P*(13) | P*(13) | P*(13) | P*(13) | P*(13) |

Note
*1 sustrate + HC +
*2 phase film
*3 P* = polarizer
*4 low RI layer = low refractive index layer
*5 Numerl within bracket refers to Production Examople number
*6 BS = biaxially stretched film

These results show the following. Good and uniform images for broad viewing angles, when images are viewed in the perpendicular direction or obliquely at a polar angle within 80 degree, can be attained by a vertical alignment (VA) mode liquid crystal display unit having at least one biaxial optical anisotropic substance sheet and a VA mode liquid crystal cell between a pair of polarizers; wherein a multilayered body consisting of the total biaxial optical anisotropic substance sheet or sheets and the liquid crystal cell satisfies the formula: |R₄₀−R₀|≦35 nm, and nₓ>n_{y}>n_{z}, and wherein the light emission side polarizing sheet is provided with a low refractive index layer comprising an aerogel and having a refractive index of not larger than 1.37.

In contrast to the liquid crystal cell unit of the present invention, a liquid crystal display unit with |R₄₀−R₀|=38 nm in Comparative Example 1 gives good images when viewed in the perpendicular direction, but, images at black display are not satisfactory when viewed at a polar angle of 45 degree, and the contrast (CR) is poor. Even though the liquid crystal display unit has a biaxial optical anisotropic substance sheet and a liquid crystal cell between a pair of polarizers, and the formula |R₄₀−R₀|≦35 nm is satisfied, but, when a low refractive index layer is not provided as in Comparative Example 2, or a low refractive index layer has a refractive index of 1.40 as in Comparative Example 3, good images are viewed for a brand viewing angle, but, the quality of images are not satisfactory because the reflectivity is high and glare and mirroring occur.

### INDUSTRIAL APPLICABILITY

The liquid crystal display unit of the present invention is characterized as having a broad viewing angle, exhibiting no or minimized undesirable mirroring, having an enhanced abrasive resistance, and giving good qualified images at black display for broad viewing angles, and homogeneous images with a high contrast. Therefore, the liquid crystal display unit can be widely used, and is especially suitable for a large-size flat panel display, for example.

1. A vertical alignment (VA) mode liquid crystal display unit having at least one biaxial optical anisotropic substance sheet and a liquid crystal cell between a light emission side polarizing sheet comprising a light emission side polarizer, and a light incident side polarizing sheet comprising a light incident side polarizer, characterized in that:
the entire biaxial optical anisotropic substance sheet satisfies the following formula:
nₓ>n_{y}>n_{z}
where nₓ and n_{y} are in-plane principal refractive indexes of the entire biaxial optical anisotropic substance sheet and n, is a principal refractive index in the thickness direction thereof;
the light emission side polarizing sheet is provided with a low refractive index layer comprising an aerogel and having a refractive index of not larger than 1.37, laminated on a light emission side of the light emission side polarizing sheet; and
a multilayered body consisting of the total biaxial optical anisotropic substance sheet or sheets and the liquid crystal cell satisfies the following formula:

|R₄₀−R₀≦35 nm
where R₀ is a retardation as measured without imposition of voltage when light having a wavelength of 550 nm impinges vertically, and R₄₀ is a retardation as measured without imposition of voltage when light having a wavelength of 550 nm impinges at an inclination angle of 40 degrees from the normal to the direction of the principal axis.

2. The liquid crystal display unit according to claim 1, wherein the low refractive index layer is characterized as a cured film formed from a coating material composition comprising:
(i) fine hollow particles having an outer shell comprised of a metal oxide,
(ii) at least one hydrolysis product selected from:
(ii-1) a hydrolysis product (A) obtained by hydrolysis of a hydrolyzable organosilane represented by the following general
SiX₄ formula (1):
where X is a hydrolyzable group,
(ii-2) a hydrolysis product (3) obtained by hydrolysis and copolymerization of a hydrolyzable organosilane represented by the formula (1) with a hydrolyzable organosilane having a fluorine-substituted alkyl group or groups; and
(iii) a hydrolyzable organosilane (C) having water-repellent groups in its straight-chain structure, and having at least two silicon atoms in the molecule, each of which is bonded with an alkoxy group or alkoxy groups.

3. The liquid crystal display unit according to claim 2, wherein the water-repellent groups of the hydrolyzable organosilane (C) are represented by the following general formula (2) or (3): 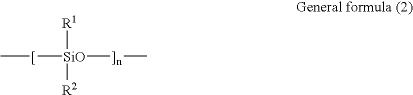
where R¹ and R² represents an alkyl group, and n is an integer of 2 to 200,
General formula (3)
—[—CF₂—]ₘ—
where m is an integer of 2 to 200.

4. The liquid crystal display unit according to claim 1, wherein the low refractive index layer is characterized as a cured film formed from a coating material composition comprising:
(i) fine hollow particles having an outer shell comprised of a metal oxide,
(ii) at least one hydrolysis product selected from:
(ii-1) a hydrolysis product (A) obtained by hydrolysis of a hydrolyzable organosilane represented by the following general formula (1):
SiX₄
where X is a hydrolyzable group, and
(ii-2) a hydrolysis product (B) obtained by hydrolysis and copolymerization of a hydrolyzable organosilane represented by the formula (1) with a hydrolyzable organosilane having a fluorine-substituted alkyl group or groups; and
(iii) a dimethyl-type silicone diol (D) represented by the following general formula (4): 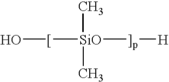
where p is a positive integer.

5. The liquid crystal display unit according to claim 4, wherein the positive integer p in the formula (4) representing the silicone diol (D) is in the range of 20 to 100.

6. The liquid crystal display unit according to claim 1, wherein the low refractive index layer is a cured film formed from a coating material composition comprising:
(i) a re-hydrolyzed product obtained by subjecting a mixture comprising fine hollow particles having an outer shell comprised of a metal oxide, and a hydrolysis product (A) obtained by hydrolysis of a hydrolyzable organosilane represented by the following general formula (1):
SiX₄
where X is a hydrolyzable group, to a hydrolysis treatment whereby the hydrolysis product (A) is re-hydrolyzed; and
(ii) a hydrolysis product (3) obtained by hydrolysis and copolymerization of a hydrolyzable organosilane represented by the formula (1) with a hydrolyzable organosilane having a fluorine-substituted alkyl group or groups.

7. The liquid crystal display unit according to claim 2 or 4, wherein the coating material composition for forming the low refractive index layer further comprises:
(a) porous particles, which are prepared by subjecting a mixture comprising an alkyl silicate, a solvent, water and a catalyst for hydrolysis and polymerization, to a hydrolysis-polymerization whereby the alkyl silicate is hydrolyzed and polymerized; and then removing the solvent by drying the hydrolysis-polymerization product; and/or
(b) porous particles having a cohesion average particle diameter in the range of 10 nm to 100 nm, which are prepared by subjecting a mixture comprising an alkyl silicate, a solvent, water and a catalyst for hydrolysis and polymerization, to a hydrolysis-polymerization whereby the alkyl silicate is hydrolyzed and polymerized; terminating polymerization before the polymerization mixture is gelled to give a stabilized organosilica sol; and then removing the solvent by drying the organosilica sol.

8. The liquid crystal display unit according to claim 2, 4 or 6, wherein the hydrolysis product (A) comprises a partially or completely hydrolyzed product having a weight average molecular weight of at least 2,000 which is prepared by hydrolyzing the hydrolyzable organosilane of the formula (1) in the presence of water in amount such that the molar ratio of [H₂O]/[X] is in the range of 1.0 to 5.0 and further in the presence of an acid catalyst.

9. The liquid crystal display unit according to claim 1, wherein the light transmission axis of the light emission side polarizer or the light transmission axis of the light incident side polarizer is approximately parallel or approximately perpendicular to the slow axis of the multilayered body consisting of the total biaxial optical anisotropic substance sheet or sheets and the liquid crystal cell without imposition of voltage.
